(19) United States
(12) Patent Application Publication
(10) Pub. No.: US 2009/0003795 A1
(43) Pub. Date: Jan. 1, 2009

(54) VIDEO REPRODUCTION DEVICE

(75) Inventor: Daisuke Yashima, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/163,892

(22) Filed: Jun. 27, 2008

(30) Foreign Application Priority Data
Jun. 29, 2007 (JP) 2007-173279

(51) Int. Cl. H04N 5/93

(52) U.S. Cl. 386/52

(57) ABSTRACT

According to one embodiment, a video reproduction device in which a resolution of a video content is limited to a limit value, the device comprises a display unit configured to reduce the resolution of the video content to the limit value and display a reduced content in a smaller size, an input unit configured to designate a part of the reduced content displayed by the display unit, and a recording unit configured to record a designated part of the reduced content together with a time stamp of the video content.

### CROSS-REFERENCE TO RELATED APPLICATIONS

This application is based upon and claims the benefit of priority from Japanese Patent Application No. 2007-173279, filed Jun. 29, 2007, the entire content of which are incorporated herein by reference.

### BACKGROUND

1. Field

One embodiment of the invention relates to a video reproduction device with a limited resolution of video content.

2. Description of the Related Art

If the resolution or the aspect ratio of video content fails to coincide with that of a video display device, it has been the conventional practice to display the video content in accordance with the resolution or the aspect ratio, as the case may be, of the video display device by enlarging or reducing the video content, or in other words, by upscaling or downscaling. For full-screen display of the video content of the SD (standard definition) resolution on the video display device of the HD (high definition) resolution, for example, the resolution of the SD video content is converted to the HD resolution by upscaling with the pixels in shortage generated by interpolation from the adjoining pixels. In order to make full-screen display of the video content of the HD resolution on the video display device of the SD resolution, on the other hand, the resolution of the HD video content is converted to the SD resolution by downscaling with the number of pixels reduced or averaged out.

On the other hand, the reproduction rule for using the content can be specified by the copyright protection technical standard AACS (Advanced Access Content System), which includes a setting method called an ICT flag (AACS Interim Adopter Agreement (AACS_Interim_Adopter-Agreement_{—}060215.pdf, 2.6 and AACS Spec HD DVD and DVD Prerecorded revision 0.912 (AACS_Spec_HD_DVD_and_DVD_Prerecorded_{—}0_{—}912.pdf, 3.5 page 65).

The ICT flag can be buried in the stream of video content. Assume that the ICT flag is on (“1” level) and the output interface from the video reproduction device to the video display device is an analog output. According to this rule, the resolution of the video content is required to be set to 520,000 pixels or less (called the “constrained image” in AACS) per frame. This resolution corresponds to about one fourth of the resolution of 1920×1080 pixels called the “full HD”. According to AACS, however, no specific method of reducing the resolution is set forth.

In the conventional case where a video content with the ICT flag on is reproduced, assume that the aspect ratio of the video content and that of the video display device are equal to each other and the resolution of the video display device for displaying this content is not less than 520,000 pixels. Even in that case, the video content is required to be reduced provisionally to the resolution of 520,000 pixels or less by downscaling. According to AACS, the resolution can be upscaled after being downscaled to 520,000 pixels or less. However, the image precision (pixel density), once deteriorated by downscaling, cannot be restored to the original image precision of the content by subsequent upscaling. The AACS standard specifies no specific method of upscaling after downscaling.

Also, the technique of transmitting only the video content in a specified area if the transmission band of the video content and the processing performance of the video reproduction device are limited is described in Japanese Patent Application KOKAI Publication No. 2005-142654. According to this technique, an area map calculation unit calculates an area map indicating the division areas for encoding, and then the input image and the basic layer coded image are decoded by an enhancement layer encoder. Thereafter, an enhancement layer, which is a differential video from the image obtained by enlargement to the resolution of the input image, is divided according to the area map, after which intra-frame encoding is carried out for each division area. Using an offset table indicating the storage position for each division area, the video data corresponding to the specified area is cut out only from the enhancement layer.

As described above, the process to be executed by the conventional video reproduction device is not determined if the resolution of the content output to the video display device is required to be limited.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block circuit diagram showing a video reproduction device according to an embodiment of the invention;

FIG. 2 is an exemplary flowchart showing a designated position recording operation according to a first embodiment of the invention;

FIG. 3 is an exemplary schematic diagram for explaining the designated position recording operation according to the first embodiment of the invention;

FIG. 4 is an exemplary flowchart showing a partial high-resolution display operation according to the first embodiment of the invention;

FIG. 5 is an exemplary diagram showing one example of a partial high-resolution display according to the first embodiment of the invention;

FIG. 6 is an exemplary diagram showing another example of the partial high-resolution display according to the first embodiment of the invention;

FIG. 7 is an exemplary flowchart showing the partial high-resolution display operation according to a second embodiment of the invention;

FIGS. 8A, 8B, and 8C are exemplary diagrams showing an example of the partial high-resolution display according to the second embodiment of the invention;

FIG. 9 is an exemplary flowchart showing a partial high-resolution display operation according to a third embodiment of the invention;

FIG. 10 is an exemplary flowchart showing a partial high-resolution display operation according to a fourth embodiment of the invention;

FIG. 11 is an exemplary diagram showing an example of the partial high-resolution display according to the fourth embodiment of the invention;

FIGS. 12A and 12B show an exemplary flowchart of a partial high-resolution display operation according to a fifth embodiment of the invention;

FIG. 13 is an exemplary diagram showing an example of the partial high-resolution display according to the fifth embodiment of the invention;

FIG. 14 is an exemplary flowchart showing a partial high-resolution display operation according to a sixth embodiment of the invention;

FIG. 15 is an exemplary flowchart showing a partial high-resolution display operation according to a seventh embodiment of the invention;

FIG. 16 is an exemplary flowchart showing a partial high-resolution display operation according to an eighth embodiment of the invention;

FIGS. 17A and 17B show an exemplary flowchart of a partial high-resolution display operation according to a ninth embodiment of the invention;

FIG. 18 is an exemplary flowchart showing a partial high-resolution display operation according to a tenth embodiment of the invention;

FIG. 19 is an exemplary diagram showing an example of the partial high-resolution display according to the tenth embodiment of the invention;

FIG. 20 is an exemplary flowchart showing a partial high-resolution display operation according to an eleventh embodiment of the invention;

FIG. 21 is an exemplary diagram showing an example of the partial high-resolution display according to the eleventh embodiment of the invention;

FIG. 22 is an exemplary flowchart showing a partial high-resolution display operation according to a twelfth embodiment of the invention;

FIGS. 23A, 23B, and 23C are exemplary diagrams showing an example of the partial high-resolution display according to the twelfth embodiment of the invention;

FIGS. 24A and 24B show an exemplary flowchart of a partial high-resolution display operation according to a thirteenth embodiment of the invention;

FIGS. 25A, 25B, and 25C are exemplary diagrams showing an example of the partial high-resolution display according to the thirteenth embodiment of the invention;

FIGS. 26A and 26B show an exemplary flowchart of a partial high-resolution display operation according to a fourteenth embodiment of the invention;

FIGS. 27A and 27B show an exemplary flowchart of a partial high-resolution display operation according to a fifteenth embodiment of the invention;

FIGS. 28A and 28B show an exemplary flowchart of a partial high-resolution display operation according to a sixteenth embodiment of the invention; and

FIGS. 29A and 29B show an exemplary flowchart of a partial high-resolution display operation according to a seventeenth embodiment of the invention.

### DETAILED DESCRIPTION

Various embodiments according to the invention will be described hereinafter with reference to the accompanying drawings. In general, according to one embodiment of the invention, a video reproduction device in which a resolution of a video content is limited to a limit value, the device comprises a display unit configured to reduce the resolution of the video content to the limit value and display a reduced content in a smaller size; an input unit configured to designate a part of the reduced content displayed by the display unit; and a recording unit configured to record a designated part of the reduced content together with a time stamp of the video content.

According to an embodiment, if the resolution is limited by the reproduction rule of the video content, the video content is not displayed by simple downscaling or upscaling as in the prior art, but displayed with the same precision as if not limited by the reproduction rule only in an arbitrary part of the video content. Although the description that follows deals with AACS as an example of the content reproduction rule, any rule other than AACS is applicable as long as the resolution (number of pixels) adapted for display is limited.

### First Embodiment

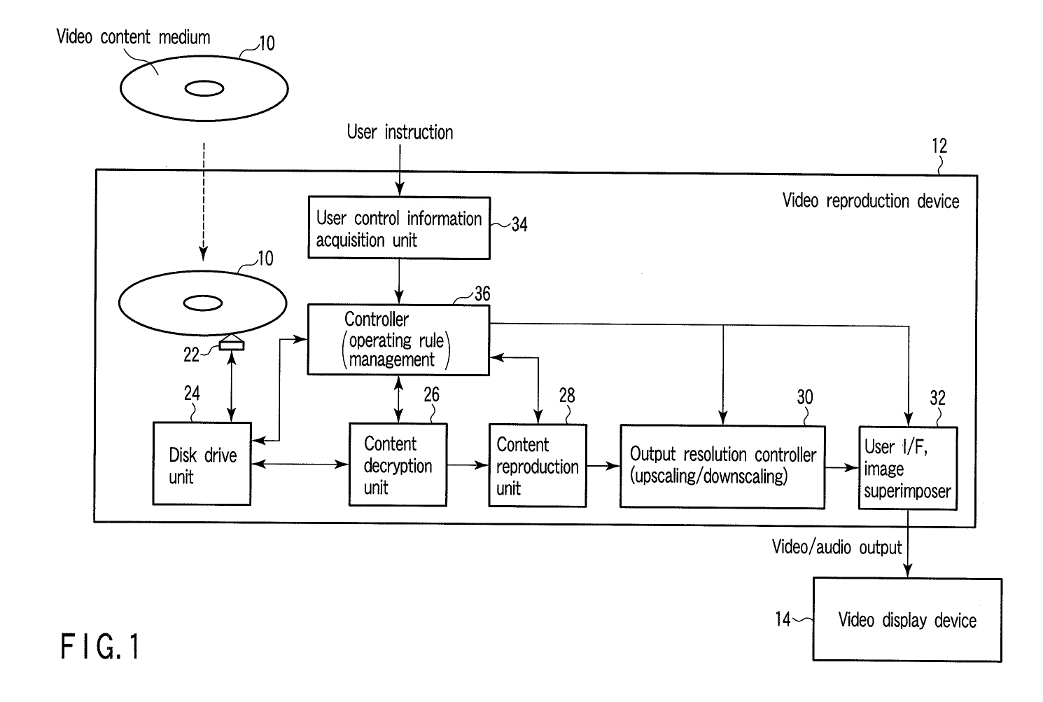

FIG. 1 is an exemplary diagram showing the configuration of a video reproduction device according to a first embodiment of the invention.

A video content medium 10 such as DVD (digital versatile disk) is set in a video reproduction device 12. The content information is read from the medium 10 by a pickup unit 22 and a disk drive unit 24. This information is output to a video display device 14 as a video/audio signal through a content decryption unit 26, a content reproduction unit 28, an output resolution controller (upscale/downscale unit) 30 and a user I/F and image superimposer 32. The video reproduction device 12 also includes a controller (reproduction rule management unit) 36 connected with a user control information acquisition unit 34 for receiving a user instruction. The disk drive unit 24, the content decryption unit 26, the content reproduction unit 28, the output resolution controller 30 and the user I/F and plural image superimposer 32 are controlled by the controller 36.

According to the first embodiment, the video content having the HD resolution is downscaled by AACS. The downscaled image, however, is not displayed with a uniform low resolution in its entirety but with a high precision only in the area designated by the user (partial high-resolution display). If the resolution only in this area is not more than the limit resolution (520,000 pixels for AACS), the content in the designated area is displayed as it is, while if the resolution in this area is more than the limit resolution, on the other hand, the video content is downscaled to the limit resolution.

This partial high-resolution display area is selected by the user using a pointing device or the like at the time of the whole uniform low-resolution reproduction of the content, and the coordinates of the area are recorded in time series at the time of selection together with the time stamp of the content. At the time of the second and subsequent reproduction sessions, these pieces of coordinate information are read in time series for the partial high-resolution reproduction.

If the resolution of the video display device is not known, the coordinates are desirably recorded using the coordinate system for the resolution of the video content before downscaling (reduction).

The user interface for position designation may designate one point in the partial high-resolution display area desired for high precision display (for example, one point at the center of the display area in a known shape), or a frame corresponding to the partial high-resolution display area in the shape designated by the pointing device. In the latter case, the frame is displayed in a scale reduced in accordance with the reduction ratio due to the whole uniform low-resolution display.

The coordinates may be designated intermittently in discontinuous way so that the video reproduction device may generate the coordinates for the nondesignated period by linear interpolation or Bezier interpolation. A similar effect can be produced by this interpolation not only at the time of recording the designated coordinates but at the time of the partial high-resolution display described later using the designated coordinates.

The designated coordinates for the partial high-resolution display are not necessarily recorded by a device limited in resolution by the reproduction rule. If the resolution is not limited, the whole uniform low-resolution display is not required, but the coordinates may be recorded by executing a similar process on the normal display screen.

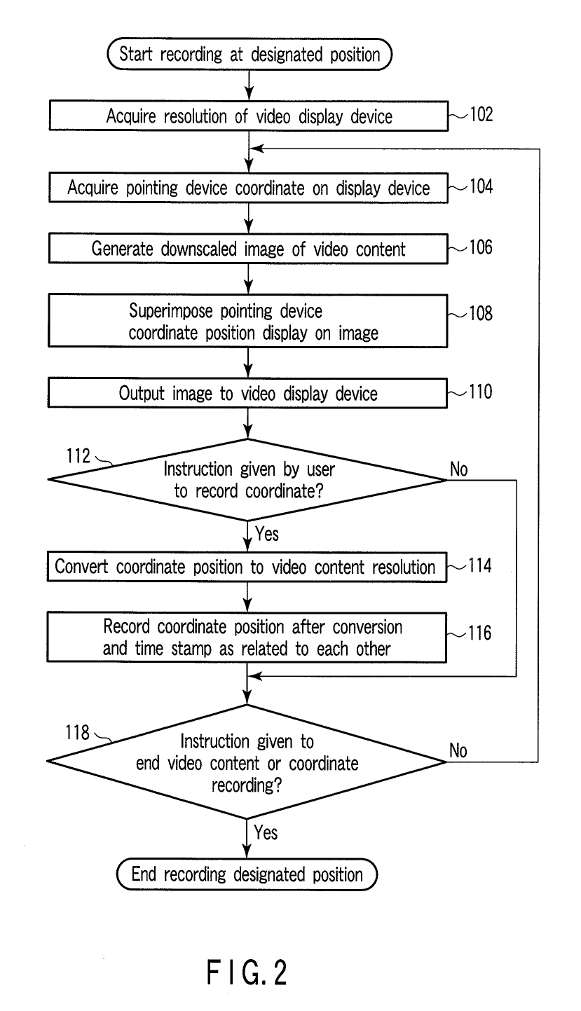

FIG. 2 is a flowchart showing the operation for designating the partial high-resolution display range in the whole uniform low-resolution display and recording the designated position.

At block 102, the resolution of the video display device 14 is acquired.

At block 104, the coordinate position of the pointing device on the video display device 14 is acquired. The pointing device is displayed under the control of the user control information acquisition unit 34 in accordance with the user instruction and may assume an arrow indicating the designated point or a frame shape indicating the particular area.

At block 106, a downscaled image (reduced to the limit resolution) of the video content is generated.

At block 108, the cursor displayed at the coordinate position of the pointing device is superimposed on the downscaled image.

At block 110, this image is output to the video display device 14.

At block 112, it is determined whether the recording mode for the cursor position coordinate is selected by the user or not. If the recording mode is selected, the flow goes to block 114. If not, the flow goes to block 118.

At block 114, the coordinate of the designated position (the coordinate on the video display device 14) is converted into the coordinate of the video content.

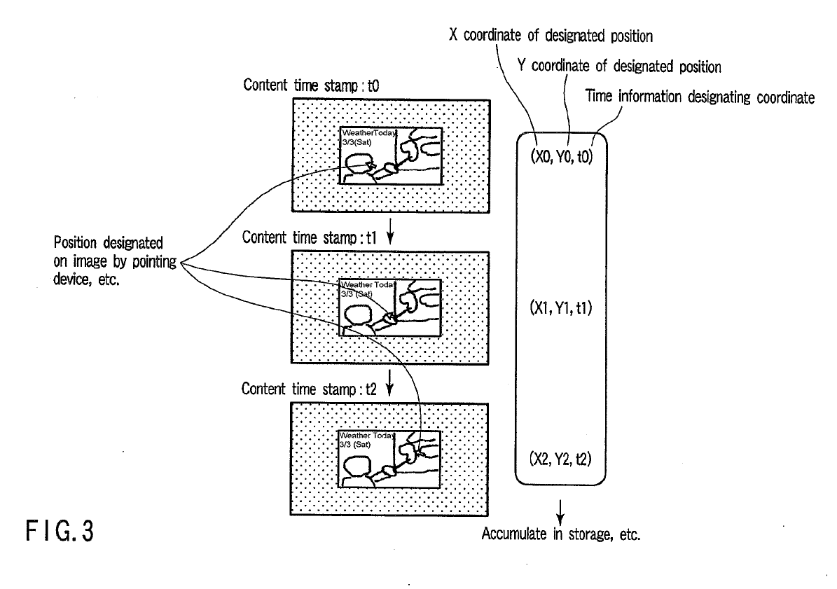

At block 116, the coordinate positions after conversion and time stamps are recorded in associated with each other. FIG. 3 shows an example of the recording of the coordinate positions and time stamps related to each other. The storage for recording may be a video content storage medium 10, or a nonvolatile memory, not shown, arranged in the video reproduction device 12.

At block 118, it is determined whether the instruction to end the display of video content or to end the recording of coordinate is given. If the instruction is given, the flow terminates. If not, the flow returns to block 104.

By the process described above, the desired area for the partial high-resolution display is selected and recorded.

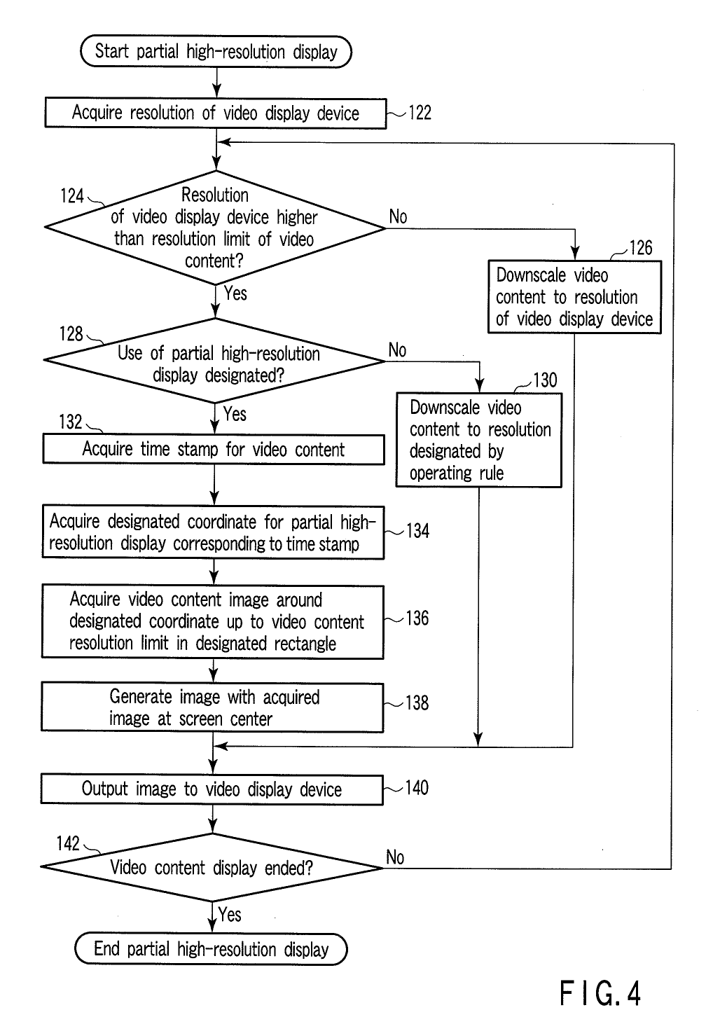

FIG. 4 is a flowchart showing the partial high-resolution display operation performed based on the information recorded as shown in FIG. 2.

At block 122, the resolution of the video display device 14 is acquired.

At block 124, it is determined whether the resolution of the video display device 14 is higher than the resolution (limited resolution) of the video content or not. If the resolution of the video display device 14 is higher than the limited resolution, the flow goes to block 128. If not, the flow goes to block 126.

At block 126, the resolution of the video content is downscaled to that of the video display device 14. Thereafter, the downscaled image is output to the video display device 14 at block 140.

At block 142, it is determined whether the video content display is ended or not. If it is ended, the flow terminates. If not, the flow returns to block 124.

At block 128, it is determined whether the partial high-resolution display is designated by the user or not. If the partial high-resolution display is not designated, the resolution of the video content is downscaled to the resolution designated by the reproduction rule at block 130. Thereafter, the flow goes to block 140.

If the partial high-resolution display is designated, the time stamps of the video content are acquired at block 132.

At block 134, the coordinates designated for the partial high-resolution display recorded in correspondence with the acquired time stamps acquired.

At block 136, the image of the video content is acquired in an area of a predetermined shape designated around the acquired coordinate. For example, the image in a rectangular area of a predetermined size with the center at the acquired coordinate is acquired. The resolution of the acquired image is the maximum one in a range not exceeding the resolution limit value of the video content as long as the resolution of the video content in the rectangular area does not exceed the resolution limit value. If the resolution of the video content in the rectangular area does not exceed the resolution limit, the video content is acquired as it is. If the resolution of the video content in the rectangular area exceeds the resolution limit, on the other hand, the video content is acquired after downscaling the resolution to the resolution limit value. The shape of the area for acquiring the image, if within the resolution limit, may have either the same aspect ratio as or a different aspect ratio from the original image. This shape is not limited to a rectangle and may be a circle. Further, it may be divided into a plurality of small areas.

At block 138, an image with the acquired image at the center of the screen is generated.

At block 140, the generated image is output to the video display device 14.

At block 142, it is determined whether the video content display ends or not. If the display ends, the flow terminates, or the flow returns to block 124 otherwise.

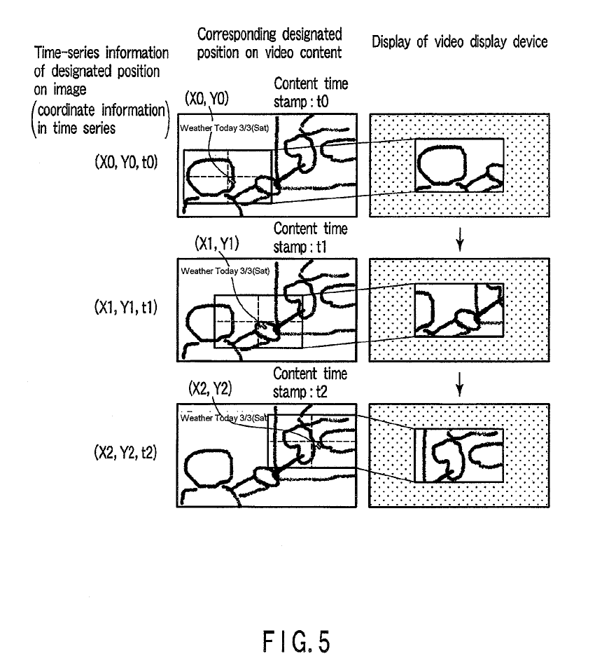

FIG. 5 shows an example of the image display by the operation of block 140 shown in FIG. 4.

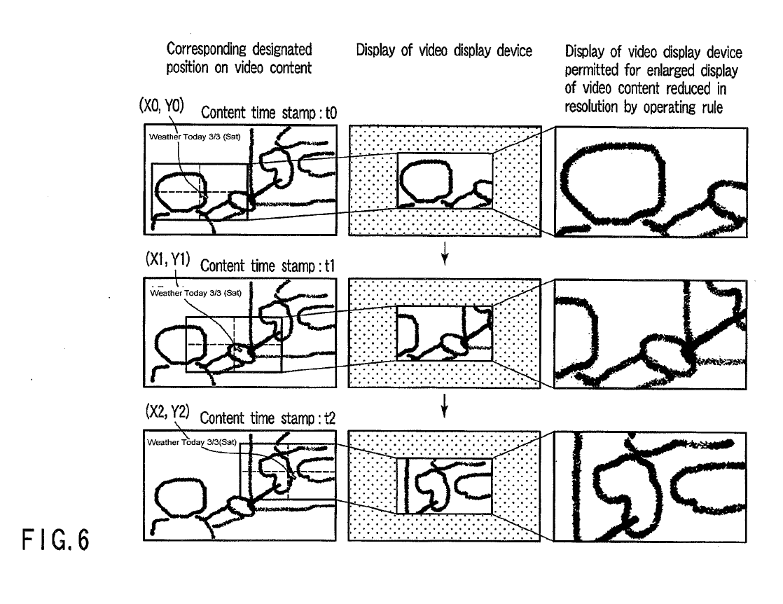

If the reproduction rule permits a downscaled image to be upscaled, the downscaled image is upscaled and displayed at block 140 as shown in FIG. 6. The precision of each image shown in FIG. 5 is not deteriorated as compared with the original image, and the precision of each image is not deteriorated as shown in FIG. 6.

As explained above, according to the first embodiment, the recording of the designated position for partial high-resolution display and the image display in partial high-resolution corresponding to the recorded data are realized.

Now, the video reproduction device according to other embodiments of the invention will be explained. In these other embodiments, the hardware configuration of the video reproduction device is identical with the one shown in FIG. 1, and therefore, no block diagram is shown.

### Second Embodiment

According to the first embodiment, the partial high-resolution display area is designated in advance, and after recording information, the partial high-resolution display is carried out based on this recorded information in another reproduction session. According to the second embodiment, on the other hand, the whole video content are reproduced and displayed normally by downscaling the video content to the resolution limit specified by the reproduction rule, and in accordance with the user instruction with the pointing device or the like, an arbitrary area is partially displayed with high resolution at an arbitrary timing.

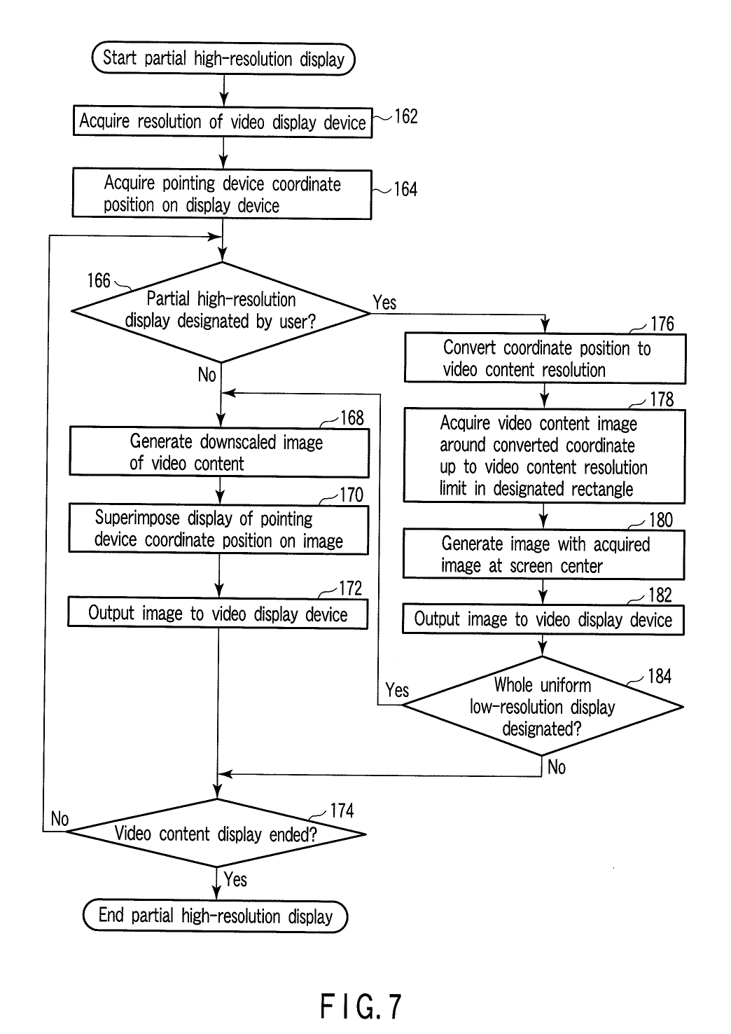

FIG. 7 is a flowchart showing the operation of partial high-resolution display according to the second embodiment.

At block 162, the resolution of the video display device 14 is acquired.

At block 164, the coordinate of the pointing device on the video display device 14 is acquired.

At block 166, it is determined whether the partial high-resolution display mode has been selected by the user or not. If yes, the flow goes to the partial high-resolution display mode at block 176. If the partial high-resolution display mode is not selected, a downscaled image (limited resolution) of the video content is generated at block 168.

At block 170, the cursor displayed at the coordinate position of the pointing device is superimposed on the downscaled image.

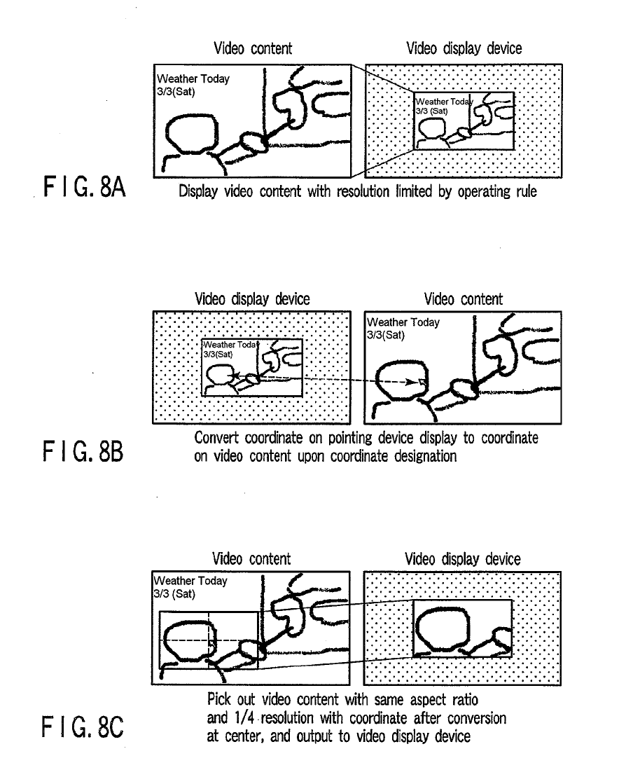

At block 172, this image is output to the video display device 14. FIG. 8A shows an example of the particular image.

At block 174, it is determined whether the video content display ends or not. If the video content display ends, the process terminates, while the flow returns to block 166 otherwise.

If the partial high-resolution display mode is selected at block 166, the coordinate of the position designated by the pointing device is converted into the coordinate of the video content resolution (FIG. 8B) at block 176.

At block 178, the image of the video content is acquired in an area of a predetermined shape designated around the acquired coordinate after conversion. For example, the image in a rectangular area of a predetermined size with the center at the acquired coordinate after conversion is acquired. The resolution of the acquired image is the maximum one in a range not exceeding the resolution limit value of the video content as long as the resolution of the video content in the rectangular area does not exceed the resolution limit value. If the resolution of the video content in the rectangular area does not exceed the resolution limit, the video content is acquired as it is. If the resolution of the video content in the rectangular area exceeds the resolution limit, on the other hand, the video content is acquired after downscaling the resolution to the resolution limit value.

At block 180, an image with the acquired image at the center of the screen is generated.

At block 182, the generated image is output to the video display device 14. FIG. 8C shows an example of the partial high-resolution images. Each partial high-resolution image is kept at the same position as long as the designated position is not changed by the user using the pointing device.

At block 184, it is determined whether the user designates the whole uniform low-resolution display mode or not. If the whole uniform low-resolution display mode is designated, the flow returns to block 168, while the flow goes to block 174 otherwise. The partial high-resolution display mode is not necessarily changed to the whole uniform low-resolution display mode.

According to the second embodiment, by designating the position during the display of the whole uniform low-resolution image, the whole uniform low-resolution display mode can be switched to the partial high-resolution display mode, and the partial high-resolution image around the designated area can be displayed.

### Third Embodiment

According to the third embodiment, the image acquisition position (pickout position) can be moved vertically, laterally or diagonally in the partial high-resolution display mode in accordance with the user instruction using a remote controller or the like.

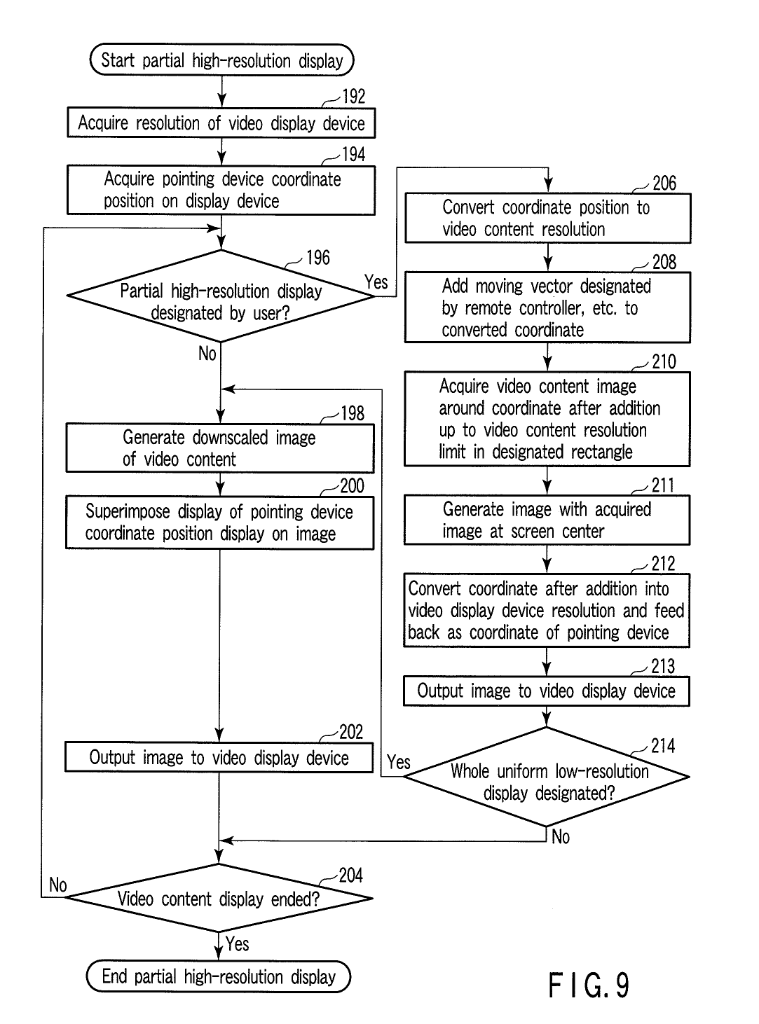

FIG. 9 is a flowchart showing the partial high-resolution display operation of the third embodiment.

At block 192, the resolution of the video display device 14 is acquired.

At block 194, the coordinate of the pointing device on the video display device 14 is acquired.

At block 196, it is determined whether the partial high-resolution display mode is selected by the user or not. If the partial high-resolution display mode is selected, the flow goes to block 206. If the partial high-resolution display mode is not selected, on the other hand, the downscaled image of the video content is generated at block 198.

At block 200, the cursor displayed at the coordinate position of the pointing device is superimposed on the downscaled image.

At block 202, this image is output to the video display device 14.

At block 204, it is determined whether the video content display ends or not. If the video content display ends, the process terminates, while the flow goes to block 196 otherwise.

If the partial high-resolution display mode is selected at block 196, the coordinate of the designated position is converted to the coordinate of the video content at block 206.

At block 208, the moving vector designated by the remote controller, etc. is added to the coordinate after conversion.

At block 210, the image of the video content is acquired in an area of a predetermined shape designated around the acquired coordinate after addition. For example, the image in a rectangular area of a predetermined size with the center at the acquired coordinate after addition is acquired. The resolution of the acquired image is the maximum one in a range not exceeding the resolution limit value of the video content as long as the resolution of the video content in the rectangular area does not exceed the resolution limit value. If the resolution of the video content in the rectangular area does not exceed the resolution limit, the video content is acquired as it is. If the resolution of the video content in the rectangular area exceeds the resolution limit, on the other hand, the video content is acquired after downscaling the resolution to the resolution limit value.

At block 211, an image with the acquired image as the center of the screen is generated.

At block 212, the coordinate after addition is converted to the coordinate of the video display device 14 as the coordinate of the pointing device.

At block 213, the generated image is output to the video display device 14. As a result, the coordinate for picking out the video content can be easily moved by addition and subtraction in accordance with the direction designated by the user after the partial high-resolution display. This coordinate change may cause a difference between the position where the video content is picked out and the coordinate of the pointing device at the time of switching (or returning) the display image to the whole uniform low-resolution display image. As soon as the coordinate of the pickout coordinate is added or subtracted at block 208, therefore, the coordinate of the pointing device is also desirably added or subtracted accordingly. If the coordinate system of the pointing device is different from that of the video content, the amount of addition or subtraction may also be required to be changed.

At block 214, it is determined whether the whole uniform low-resolution display mode is designated by the user or not. If the whole uniform low-resolution display mode is designated, the flow returns to block 198, while the flow goes to block 204 otherwise.

### Fourth Embodiment

According to the fourth embodiment, information is displayed as to which part of the whole screen of the video content is on display in the partial high-resolution display mode. This can be realized by displaying the numerical value of the coordinate picked out in superposition on the partial high-resolution display. According to this embodiment, however, as shown in FIG. 11, the result is visually expressed in such a manner that a rectangle having the aspect ratio of the video content, together with a partial high-resolution display area above the rectangle, is displayed in superposition over a part other than the partial high-resolution display area on the video display device 14.

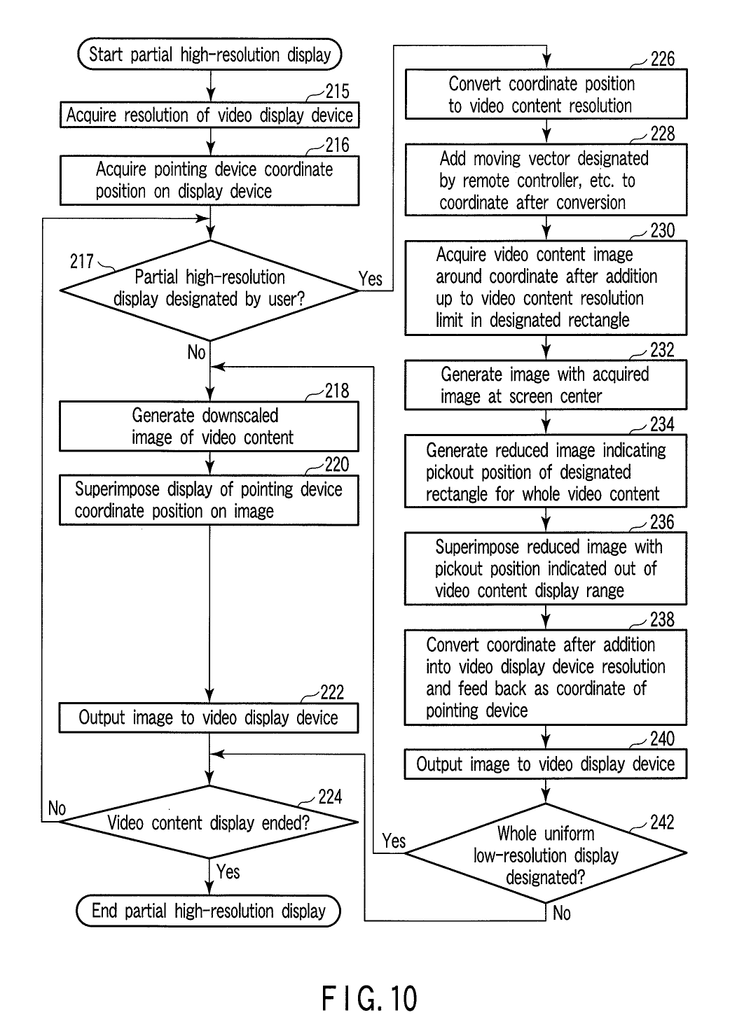

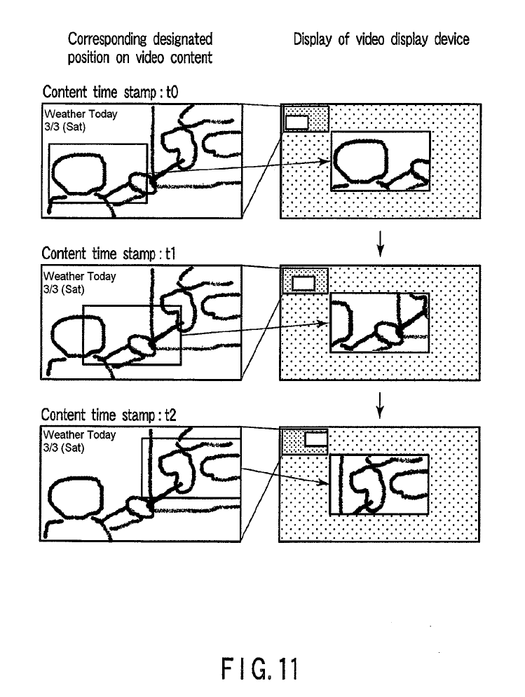

FIG. 10 is a flowchart showing the partial high-resolution display operation according to the fourth embodiment.

At block 215, the resolution of the video display device 14 is acquired.

At block 216, the coordinate of the pointing device on the video display device 14 is acquired.

At block 217, it is determined whether the partial high-resolution display mode is selected by the user or not. If the partial high-resolution display mode is selected, the flow goes to block 226. If the partial high-resolution display mode is not selected, on the other hand, a downscaled image of the video content is generated at block 218.

At block 220, the cursor displayed at the coordinate position of the pointing device is superimposed on the downscaled image.

At block 222, this image is output to the video display device 14.

At block 224, it is determined whether the video content display ends or not. If the video content display ends, the process terminates, while the flow returns to block 217 otherwise.

If the partial high-resolution display mode is selected at block 217, the coordinate of the designated position is converted into the coordinate of the video content at block 226.

At block 228, the moving vector designated by the remote controller, etc. is added to the coordinate after conversion.

At block 230, the image of the video content is acquired in an area of a predetermined shape designated around the acquired coordinate after addition. For example, the image in a rectangular area of a predetermined size with the center at the acquired coordinate after addition is acquired. The resolution of the acquired image is the maximum one in a range not exceeding the resolution limit value of the video content as long as the resolution of the video content in the rectangular area does not exceed the resolution limit value. If the resolution of the video content in the rectangular area does not exceed the resolution limit, the video content is acquired as it is. If the resolution of the video content in the rectangular area exceeds the resolution limit, on the other hand, the video content is acquired after downscaling the resolution to the resolution limit value.

At block 232, an image with the acquired image as the screen center is generated.

At block 234, a reduced image is generated for indicating the position at which the designated rectangle is picked out for the whole video content.

At block 236, the reduced image indicating the pickout position outside the display range of the video content is displayed.

At block 238, the coordinate after addition is converted into the coordinate of the video display device 14, and is set as the coordinate of the pointing device.

At block 240, the generated image is output to the video display device 14. FIG. 11 shows an example of this image display.

At block 242, it is determined whether the whole uniform low-resolution display mode is designated by the user or not. If the whole uniform low-resolution display mode is designated, the flow returns to block 218, while the flow goes to block 224 otherwise.

### Fifth Embodiment

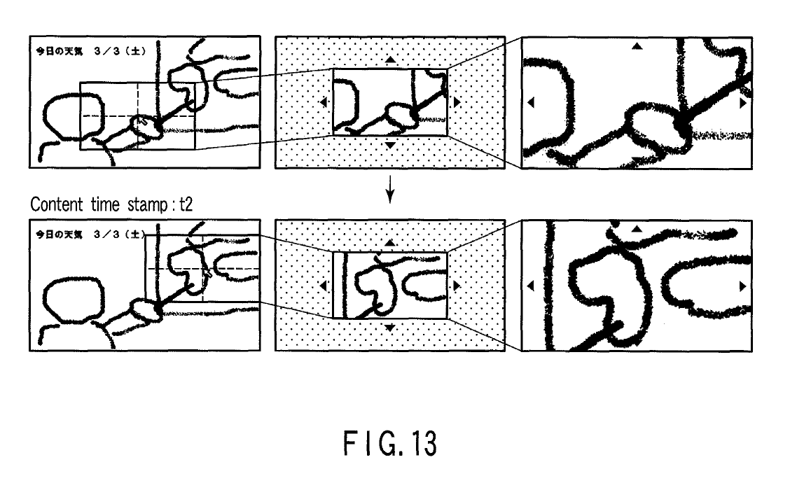

According to the fifth embodiment, a changeable direction is displayed over the reproduced image if the pickout coordinate of the video content is changed during the partial high-resolution display operation as in the third embodiment (FIG. 13).

Whether the direction is changeable or not is easily determined from the resolution of the video content, the shape of the partial high-resolution display image picked out and the present pickout coordinate.

Any means by which the direction can be determined may be employed, and such means may be displayed either over or outside the partial high-resolution display image. For further upscaling the partial high-resolution display, however, such means is desirably displayed in superposition on the partial high-resolution display image.

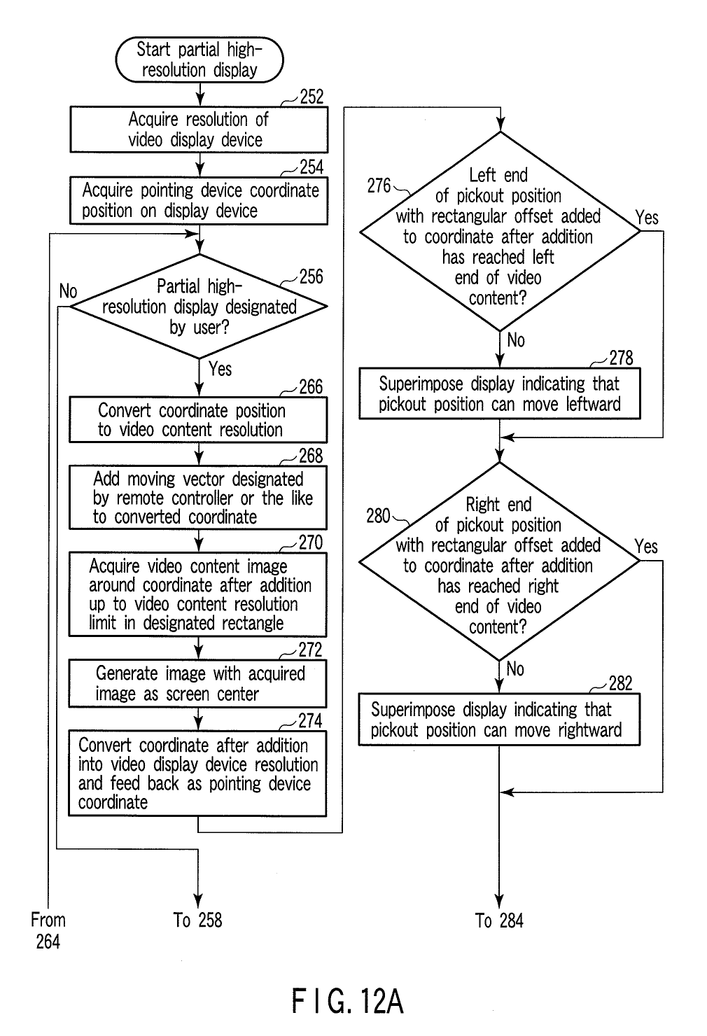

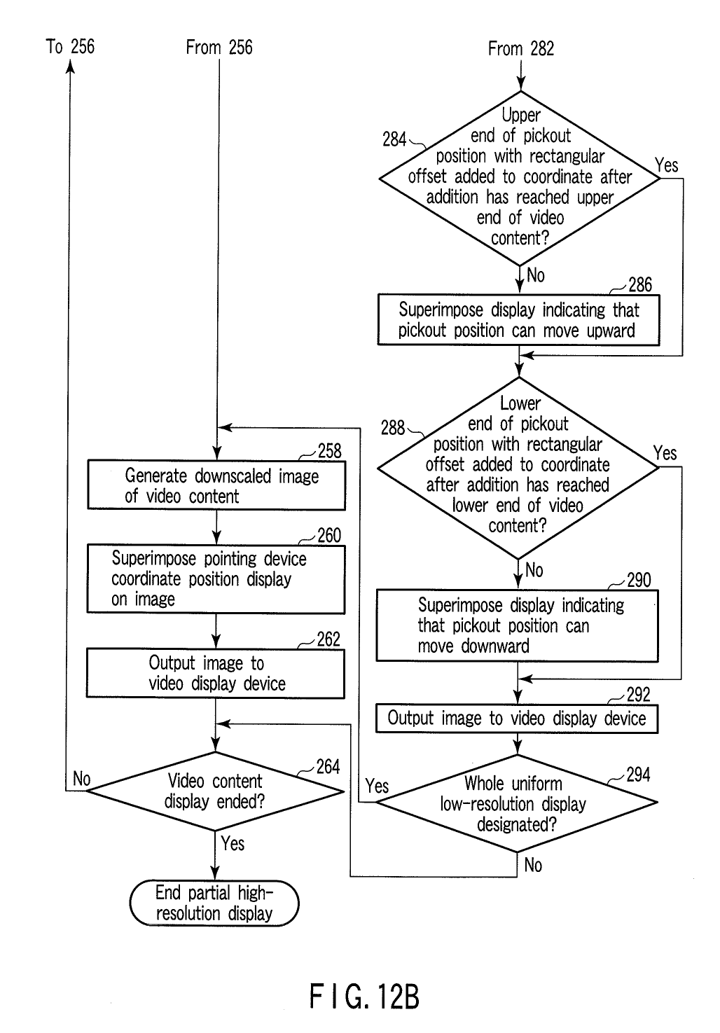

FIGS. 12A and 12B show a flowchart of the partial high-resolution display operation according to the fifth embodiment.

At block 252, the resolution of the video display unit 14 is acquired.

At block 254, the coordinate of the pointing device on the video display device 14 is acquired.

At block 256, it is determined whether the partial high-resolution display mode is selected by the user or not. If the partial high-resolution display mode is selected, the flow goes to block 266, while the flow goes to block 258 otherwise.

If the partial high-resolution display mode is not selected, on the other hand, a downscaled image of the video content is generated at block 258.

At block 260, the cursor displayed at the coordinate position of the pointing device is superimposed on the downscaled image.

At block 262, this image is output to the video display device 14.

At block 264, it is determined whether the video content display ends or not. If the video content display ends, the process terminates, while the flow returns to block 256 otherwise.

If the partial high-resolution display mode is selected at block 256, the coordinate of the designated position is converted to the coordinate of the video content at block 266.

At block 268, the moving vector designated by the remote controller or the like is added to the coordinate after conversion.

At block 270, the image of the video content is acquired in an area of a predetermined shape designated around the acquired coordinate after addition. For example, the image in a rectangular area of a predetermined size with the center at the acquired coordinate after addition is acquired. The resolution of the acquired image is the maximum one in a range not exceeding the resolution limit value of the video content as long as the resolution of the video content in the rectangular area does not exceed the resolution limit value. If the resolution of the video content in the rectangular area does not exceed the resolution limit, the video content is acquired as it is. If the resolution of the video content in the rectangular area exceeds the resolution limit, on the other hand, the video content is acquired after downscaling the resolution to the resolution limit value.

At block 272, an image with the acquired image at the center of the screen is generated.

At block 274, the coordinate after addition is converted into the coordinate of the video display device 14 and is set as the coordinate of the pointing device.

At block 276, it is determined whether the left end of the pickout position with a rectangular offset added to the coordinate after addition has reached the left end of the video content or not. If the left end is so reached, the flow goes to block 280, while the flow goes to block 278 otherwise.

At block 278, an indication that the pickout position is movable leftward (for example, a black triangle with the apex set in the movable direction as shown in FIG. 13) is displayed in superposition on the image.

At block 280, it is determined whether the right end of the pickout position with the rectangular offset added to the coordinate after addition has reached the right end of the video content or not. If the right end of the video content has been so reached, the flow goes to block 284, while the flow goes to block 282 otherwise.

At block 282, the display indicating that the pickout position is movable rightward is superimposed over the image.

At block 284, it is determined whether the upper end of the pickout position with the rectangular offset added to the coordinate after addition has reached the upper end of the video content or not. If the upper end of the video content has been so reached, the flow goes to block 288, while the flow goes to block 286 otherwise.

At block 286, the display indicating that the pickout position is movable upward is superimposed over the image.

At block 288, it is determined whether the lower end of the pickout position with the rectangular offset added to the coordinate after addition has reached the lower end of the video content or not. If the lower end of the video content has been so reached, the flow goes to block 292, while the flow goes to block 290 otherwise.

At block 290, the display indicating that the pickout position is movable downward is superimposed over the image.

At block 292, this image is output to the video display device 14.

At block 294, it is determined whether the whole uniform low-resolution display mode is designated by the user or not. If the whole uniform low-resolution display mode is designated, the flow goes to block 256, while the flow goes to block 264 otherwise.

### Sixth Embodiment

According to the sixth embodiment, the partial high-resolution display mode is changed to the whole uniform low-resolution display mode not in accordance with the user instruction, but automatically without regard to the user instruction upon lapse of a predetermined time from the start of the partial high-resolution display.

For the measurement of time, a dedicated counter may be used to start count-up when the partial high-resolution display mode starts, and to change to the whole uniform low-resolution display mode when a preset threshold value is reached. As an alternative, with the function of accessing a counter usable as a clock, a threshold value is added to the time accessed to start the partial high-resolution display, the ending time is determined in advance, so that when the ending time is reached, the partial high-resolution display mode is changed to the whole uniform low-resolution display mode.

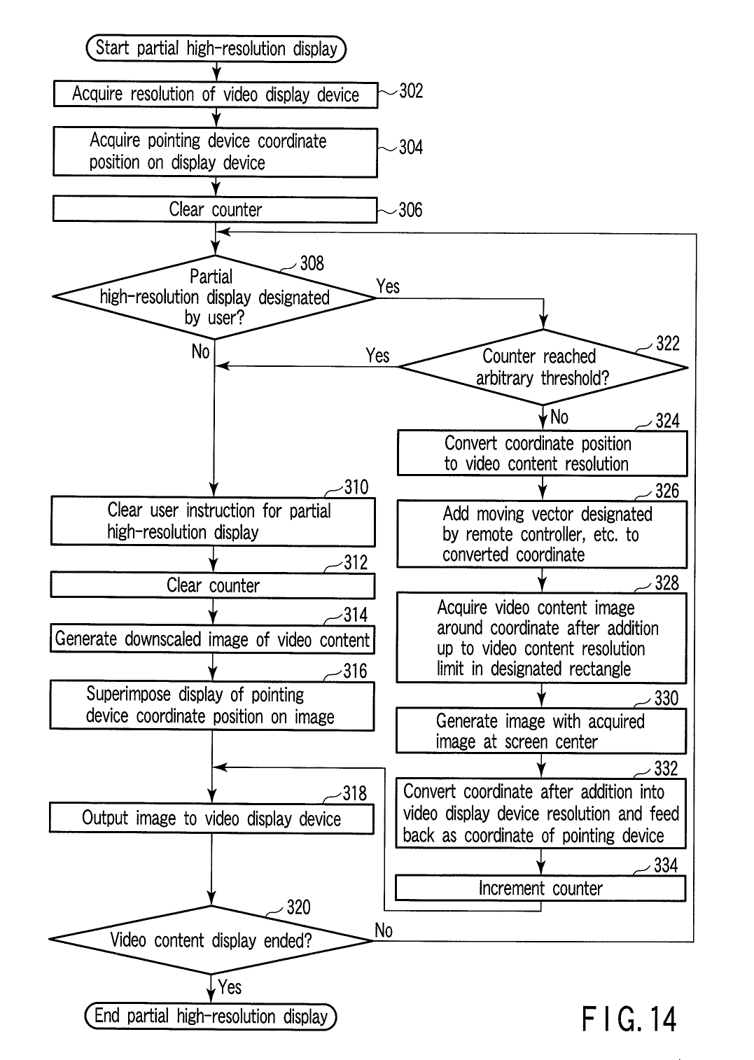

FIG. 14 is a flowchart showing the partial high-resolution display operation according to the sixth embodiment.

At block 302, the resolution of the video display device 14 is acquired.

At block 304, the coordinate of the pointing device on the video display device 14 is acquired.

At block 306, the counter for measuring the elapsed time is cleared.

At block 308, it is determined whether the partial high-resolution display mode is selected by the user. If the partial high-resolution display mode is selected, the flow goes to block 322. If the partial high-resolution display mode is not selected, the flow goes to block 310.

At block 310, the user instruction for the partial high-resolution display mode is cleared

At block 312, the counter for elapsed time measurement is cleared.

At block 314, a downscaled image of the video content is generated.

At block 316, the cursor displayed at the coordinate position of the pointing device is superimposed on the downscaled image.

At block 318, this image is output to the video display device 14.

At block 320, it is determined whether the video content display ends or not. If the video content display ends, the process terminates, while the flow returns to block 308 otherwise.

If the partial high-resolution display mode is selected at block 308, it is determined at block 322 whether the counter has reached an arbitrary threshold value. If the counter has reached the arbitrary threshold value, the flow goes to block 310 and the partial high-resolution display mode is switched to the whole uniform low-resolution display mode. If the counter has not reached the threshold value, on the other hand, the flow goes to block 324.

At block 324, the coordinate of the position designated by the pointing device is converted to the coordinate of the video content.

At block 326, a moving vector designated by the remote controller or the like is added to the coordinate after conversion.

At block 328, the image of the video content is acquired in an area of a predetermined shape designated around the acquired coordinate after addition For example, the image in a rectangular area of a predetermined size with the center at the acquired coordinate after addition is acquired. The resolution of the acquired image is the maximum one in a range not exceeding the resolution limit value of the video content as long as the resolution of the video content in the rectangular area does not exceed the resolution limit value. If the resolution of the video content in the rectangular area does not exceed the resolution limit, the video content is acquired as it is. If the resolution of the video content in the rectangular area exceeds the resolution limit, on the other hand, the video content is acquired after downscaling the resolution to the resolution limit value.

At block 330, an image with the acquired image as the center of the screen is generated.

At block 332, the coordinate after addition is converted to the coordinate of the video display device 14 and set as the coordinate of the pointing device.

At block 334, the counter for elapsed time measurement is incremented. Thereafter, the flow goes to block 318.

### Seventh Embodiment

According to the seventh embodiment, assume that the boundary of the video content such as a chapter exists in the partial high-resolution display mode. Regardless of the instruction from the user, the partial high-resolution display mode is switched automatically to the whole uniform low-resolution display mode.

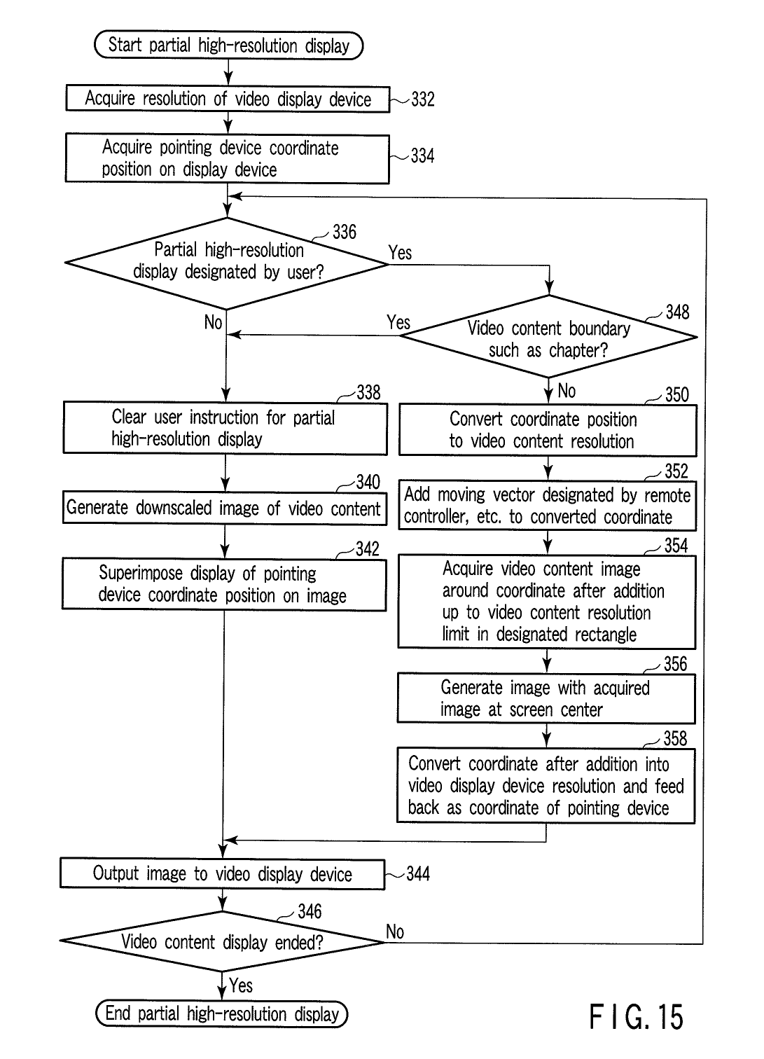

FIG. 15 is a flowchart showing the partial high-resolution display operation according to the seventh embodiment.

At block 332, the resolution of the video display device 14 is acquired.

At block 334, the coordinate of the pointing device on the video display device 14 is acquired.

At block 336, it is determined whether the partial high-resolution display mode is selected by the user. If the partial high-resolution display mode is selected, the flow goes to block 348. If the partial high-resolution display mode is not selected, the flow goes to block 338.

At block 338, the user designation of the partial high-resolution display mode is cleared.

At block 340, a downscaled image of the video content is generated.

At block 342, the cursor displayed at the coordinate position of the pointing device is superimposed on the downscaled image.

At block 344, this image is output to the video display device 14.

At block 346, it is determined whether the video content display ends or not. If the video content display ends, the process terminates, while the flow returns to block 336 otherwise.

If the partial high-resolution display mode is selected at block 336, it is determined at block 348 whether a boundary such as a chapter of the video content exists or not. If the boundary of the video content exists, the flow goes to block 338, and the partial high-resolution display mode is switched to the whole uniform low-resolution display mode. If no boundary exists, on the other hand, the flow goes to block 350.

At block 350, the coordinate of the position designated by the pointing device is converted to the coordinate of the video content.

At block 352, the moving vector designated by the remote controller or the like is added to the coordinate after conversion.

At block 354, the image of the video content is acquired in an area of a predetermined shape designated around the acquired coordinate after addition. For example, the image in a rectangular area of a predetermined size with the center at the acquired coordinate after addition is acquired. The resolution of the acquired image is the maximum one in a range not exceeding the resolution limit value of the video content as long as the resolution of the video content in the rectangular area does not exceed the resolution limit value. If the resolution of the video content in the rectangular area does not exceed the resolution limit, the video content is acquired as it is. If the resolution of the video content in the rectangular area exceeds the resolution limit, on the other hand, the video content is acquired after downscaling the resolution to the resolution limit value.

At block 356, an image with the acquired image as the center of the screen is generated.

At block 358, the coordinate after addition is converted to the coordinate of the video display device 14 and set as the coordinate of the pointing device. Thereafter, the flow goes to block 344.

### Eighth Embodiment

According to the eighth embodiment, during the partial high-resolution display, the difference is always acquired between the present full-screen video content and the immediately preceding or immediately subsequent full-screen content. This is in order to detect the scene boundary of the video content. Which difference is taken, between the present content and the immediately preceding or the immediately subsequent content, can be arbitrarily determined by implementation or user setting. As soon as this difference exceeds a threshold value, the partial high-resolution display mode is automatically switched to the whole uniform low-resolution display mode regardless of the user instruction.

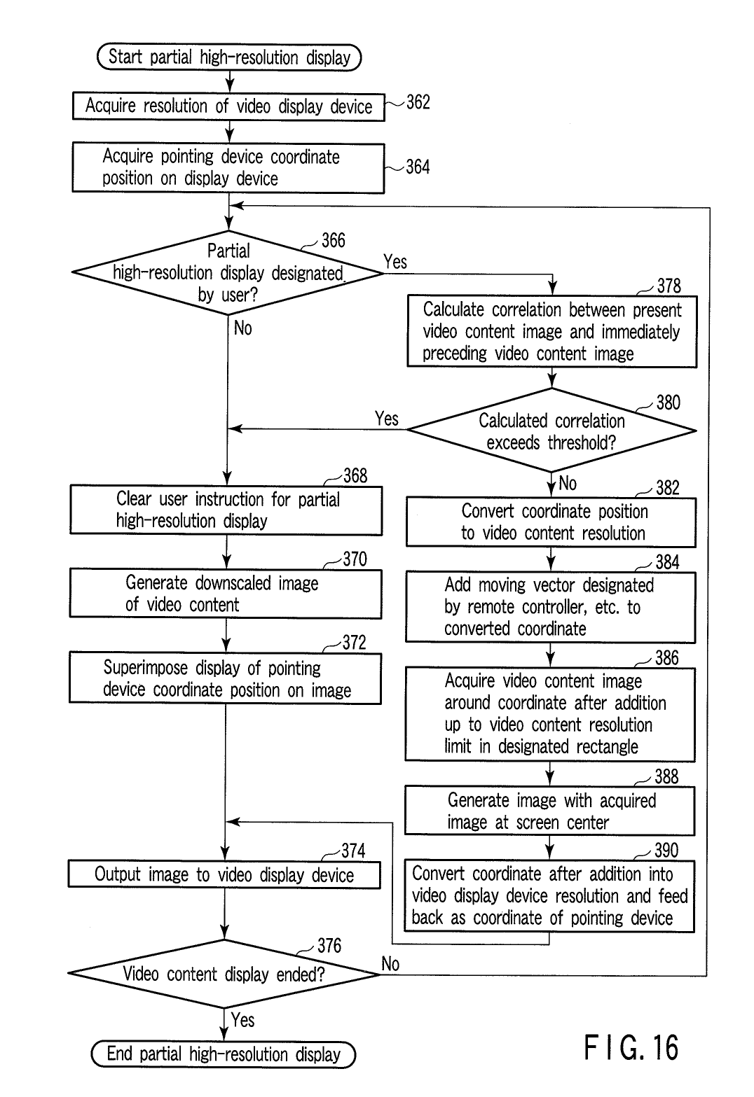

FIG. 16 is a flowchart showing the partial high-resolution display operation according to the eighth embodiment.

At block 362, the resolution of the video display device 14 is acquired.

At block 364, the coordinate of the pointing device on the video display device 14 is acquired.

At block 366, it is determined whether the partial high-resolution display mode is selected by the user. If the partial high-resolution display mode is selected, the flow goes to block 378. If the partial high-resolution display mode is not selected, the flow goes to block 368.

At block 368, the user designation of the partial high-resolution display mode is cleared.

At block 370, a downscaled image of the video content is generated.

At block 372, the cursor displayed at the coordinate position of the pointing device is superimposed on the downscaled image.

At block 374, this image is output to the video display device 14.

At block 376, it is determined whether the video content display ends or not. If the video content display ends, the process terminates, while the flow returns to block 366 otherwise.

If the partial high-resolution display mode is selected at block 366, the correlation between the present video content image and the immediately preceding video content image is calculated at block 378. The correlation can be calculated by a general method for acquiring the sum of absolute values or the square sum of differences of the pixel values of the same coordinate on two screens, and according to this embodiment, the method is not specifically limited. Also, as long as the screen having a scene boundary or a large motion is detected, the motion detection or the like can be used. The requirements of this embodiment are to have means for numerically detecting the magnitude of the difference between two images and means for switching the partial high-resolution display mode to the whole uniform low-resolution display mode according to the result of detection.

At block 380, it is determined whether the calculated correlation value exceeds a threshold or not. If the correlation value exceeds the threshold, the flow goes to block 368, while the flow goes to block 382 otherwise.

At block 382, the coordinate of the position designated by the pointing device is converted to the coordinate of the video content.

At block 384, the moving vector designated by the remote controller or the like is added to the coordinate after conversion.

At block 386, the image of the video content is acquired in an area of a predetermined shape designated around the acquired coordinate after addition. For example, the image in a rectangular area of a predetermined size with the center at the acquired coordinate after addition is acquired. The resolution of the acquired image is the maximum one in a range not exceeding the resolution limit value of the video content as long as the resolution of the video content in the rectangular area does not exceed the resolution limit value. If the resolution of the video content in the rectangular area does not exceed the resolution limit, the video content is acquired as it is. If the resolution of the video content in the rectangular area exceeds the resolution limit, on the other hand, the video content is acquired after downscaling the resolution to the resolution limit value.

At block 388, an image with the acquired image as the center of the screen is generated.

At block 390, the coordinate after addition is converted to the coordinate of the video display device 14 and set as the coordinate of the pointing device. Thereafter, the flow goes to block 374.

### Ninth Embodiment

The ninth embodiment, though similar to the eighth embodiment, is different from the eighth embodiment in that the area for determining the screen difference is limited to other than the partial high-resolution display area. According to this embodiment, unlike the eighth embodiment aimed at detecting the scene boundary or the scene with a large motion, the difference only at the part, though accompanied by a large motion on the video content but not displayed on the screen, is cumulatively added. If the accumulated value exceeds a threshold, the partial high-resolution display mode is switched automatically to the whole uniform low-resolution display mode.

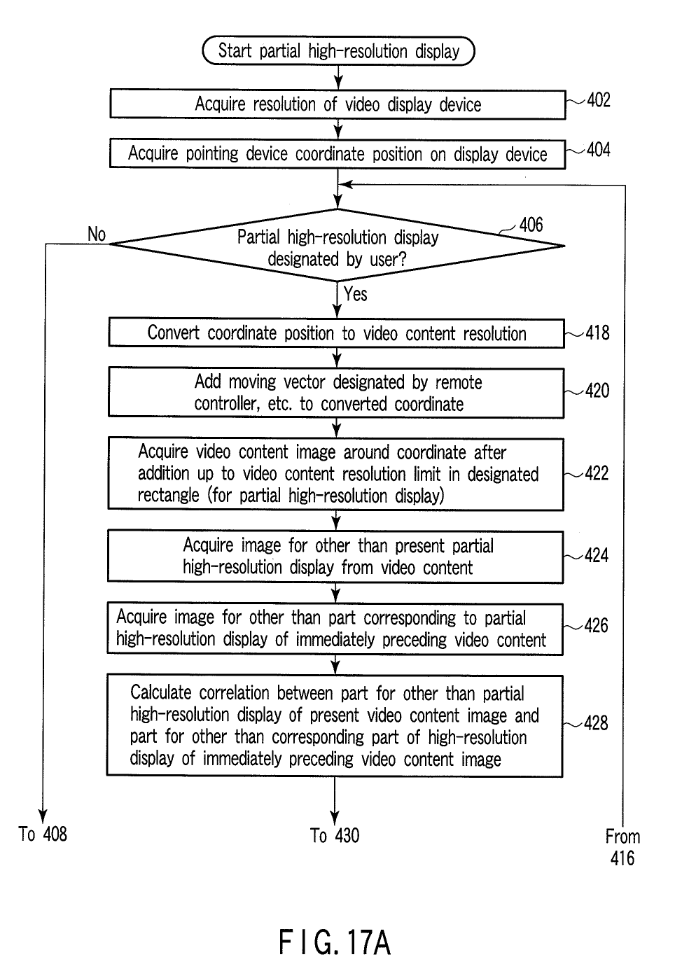

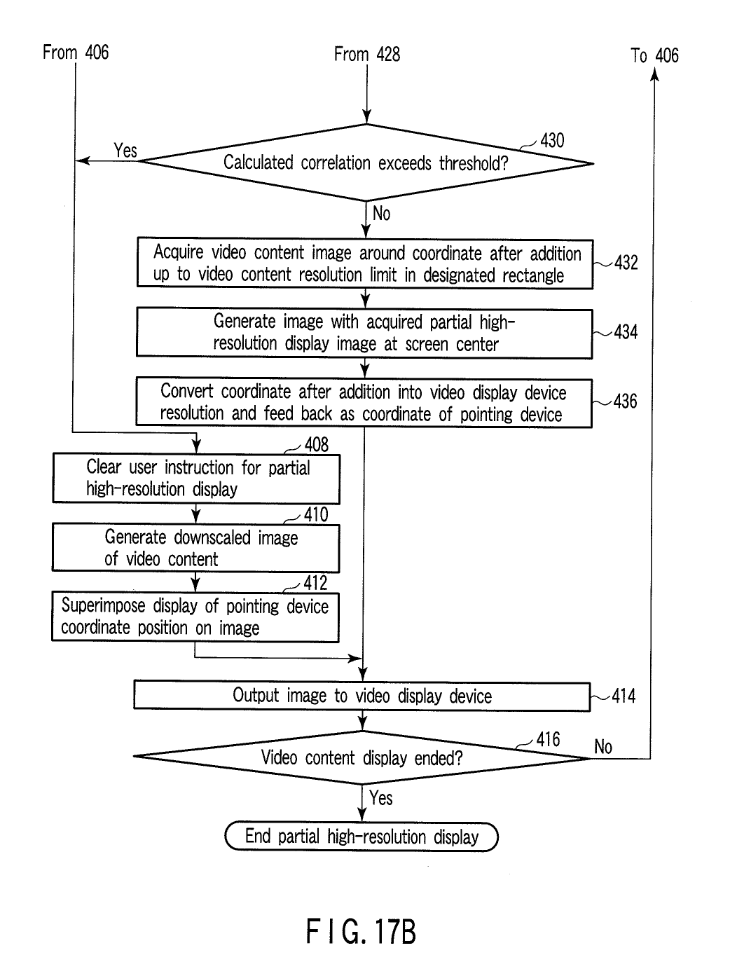

FIGS. 17A and 17B show a flowchart of the partial high-resolution display operation according to the ninth embodiment.

At block 402, the resolution of the video display device 14 is acquired.

At block 404, the coordinate of the pointing device on the video display device 14 is acquired.

At block 406, it is determined whether the partial high-resolution display mode is selected by the user. If the partial high-resolution display mode is selected, the flow goes to block 418. If the partial high-resolution display mode is not selected, the flow goes to block 408.

At block 408, the user designation of the partial high-resolution display mode is cleared.

At block 410, a downscaled image of the video content is generated.

At block 412, the cursor displayed at the coordinate position of the pointing device is superimposed on the downscaled image.

At block 414, this image is output to the video display device 14.

At block 416, it is determined whether the video content display ends or not. If the video content display ends, the process terminates, while the flow returns to block 406 otherwise.

If the partial high-resolution display mode is selected at block 406, the coordinate of the position designated by the pointing device is converted to the coordinate of the video content.

At block 420, the moving vector designated by the remote controller or the like is added to the coordinate after conversion.

At block 422, the image of the video content (a partial high-resolution display object) is acquired in an area of a predetermined shape designated around the acquired coordinate after addition. For example, the image in a rectangular area of a predetermined size with the center at the acquired coordinate after addition is acquired. The resolution of the acquired image is the maximum one in a range not exceeding the resolution limit value of the video content as long as the resolution of the video content in the rectangular area does not exceed the resolution limit value. If the resolution of the video content in the rectangular area does not exceed the resolution limit, the video content is acquired as it is. If the resolution of the video content in the rectangular area exceeds the resolution limit, on the other hand, the video content is acquired after downscaling the resolution to the resolution limit value.

At block 424, the image other than for partial high-resolution display is acquired from the video content.

At block 426, the image of the parts other than those corresponding to the present partial high-resolution display mode is acquired from the immediately preceding video content.

At block 428, the correlation value for other than the parts intended for the partial high-resolution display of the present video content and the partial high-resolution display of the immediately preceding video content is calculated.

At block 430, it is determined whether the calculated correlation value exceeds a threshold. If the correlation value exceeds the threshold, the flow goes to block 408, and the partial high-resolution display mode is switched to the whole uniform low-resolution display mode. If the calculated correlation value does not exceed the threshold, on the other hand, the flow goes to block 432.

At block 432, the image of the video content is acquired in an area of a predetermined shape designated around the acquired coordinate after addition. For example, the image in a rectangular area of a predetermined size with the center at the acquired coordinate after addition is acquired. The resolution of the acquired image is the maximum one in a range not exceeding the resolution limit value of the video content as long as the resolution of the video content in the rectangular area does not exceed the resolution limit value. If the resolution of the video content in the rectangular area does not exceed the resolution limit, the video content is acquired as it is. If the resolution of the video content in the rectangular area exceeds the resolution limit, on the other hand, the video content is acquired after downscaling the resolution to the resolution limit value.

At block 434, an image with the acquired image at the center of the screen is generated.

At block 436, the coordinate after addition is converted into the coordinate of the video display device 14 and set as the coordinate of the pointing device. Thereafter, the flow goes to block 414.

### Tenth Embodiment

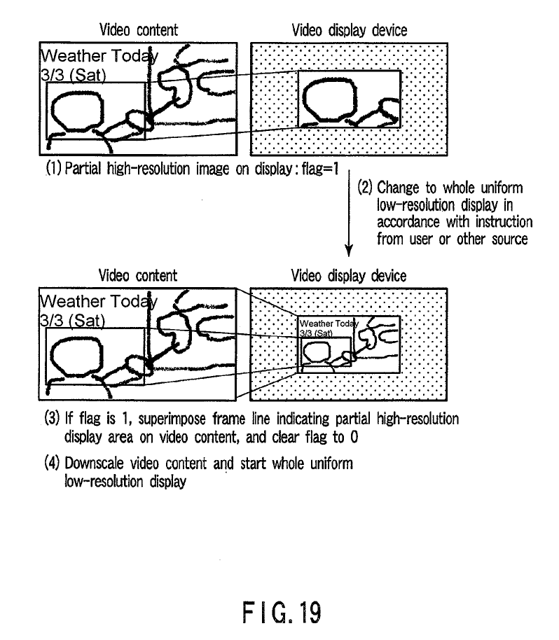

According to the tenth embodiment, a particular area of the whole video content, which corresponds to the area of the partial high-resolution display which has been switched to the whole uniform low-resolution display mode, is reproduced with a frame superimposed on the coordinate on the whole uniform low-resolution display image corresponding to the immediately preceding partial high-resolution display image (FIG. 19).

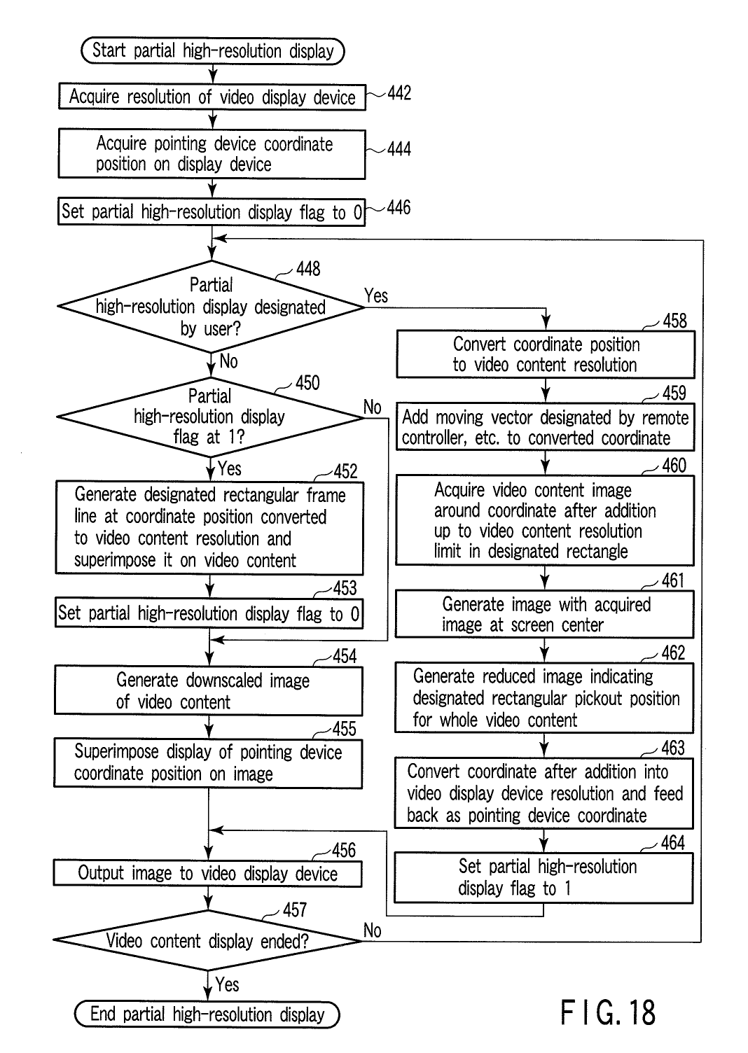

FIG. 18 is a flowchart showing the partial high-resolution display operation according to the tenth embodiment.

At block 442, the resolution of the video display device 14 is acquired.

At block 444, the coordinate of the pointing device on the video display device 14 is acquired.

At block 446, the partial high-resolution display flag is set to 0.

At block 448, it is determined whether the partial high-resolution display mode is selected by the user. If the partial high-resolution display mode is selected, the flow goes to block 458. If the partial high-resolution display mode is not selected, the flow goes to block 450.

At block 450, it is determined whether the partial high-resolution display flag is 1 or not. If the partial high-resolution display flag is 1, the flow goes to block 452, while the flow goes to block 454 otherwise.

At block 452, a designated rectangular frame is generated, as shown in FIG. 19, at the coordinate position on the pointing device converted to the resolution (coordinate) of the video content and is superimposed on the video content.

At block 453, the partial high-resolution display flag is set to 0. In order to improve the user visibility, the flag may be cleared (set to 0) several frames of the display period later so that the frame can be superimposed also on subsequent several images.

At block 454, a downscaled image of the video content is generated.

At block 456, the cursor displayed at the coordinate position of the pointing device is superimposed on the downscaled image.

At block 456, this image is output to the video display device 14.

At block 457, it is determined whether the video content display ends or not. If the video content display ends, the process terminates, while the flow returns to block 448 otherwise.

At block 458, the coordinate of the position designated by the pointing device is converted to the coordinate of the video content.

At block 459, the moving vector designated by the remote controller or the like is added to the coordinate after conversion.

At block 460, the image of the video content is acquired in an area of a predetermined shape designated around the acquired coordinate after addition. For example, the image in a rectangular area of a predetermined size with the center at the acquired coordinate after addition is acquired. The resolution of the acquired image is the maximum one in a range not exceeding the resolution limit value of the video content as long as the resolution of the video content in the rectangular area does not exceed the resolution limit value. If the resolution of the video content in the rectangular area does not exceed the resolution limit, the video content is acquired as it is. If the resolution of the video content in the rectangular area exceeds the resolution limit, on the other hand, the video content is acquired after downscaling the resolution to the resolution limit value.

At block 461, an image with the acquired image as the center of the screen is generated.

At block 462, a reduced image indicating the pickout position of the designated rectangle in the whole video content is generated.

At block 463, the coordinate after addition is converted into the coordinate of the video display device 14 and set as the coordinate of the pointing device.

At block 464, the partial high-resolution display flag is set to 1, thereafter the flow goes to block 459.

### Eleventh Embodiment

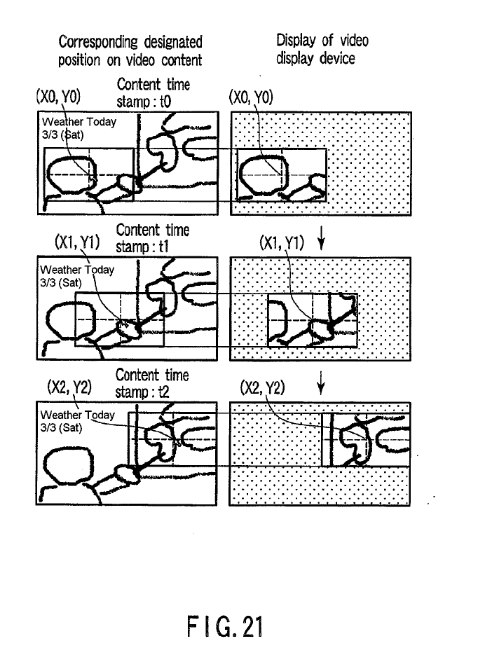

Although the partial high-resolution image is displayed at the center of the video display device 14 in the aforementioned embodiments, the eleventh embodiment is such that the partial high-resolution image is displayed at the same position as the coordinate of the video content on the video display device 14 (FIG. 21). In this case, the resolution of the video display device 14 is desirably equal to or higher than that of the video content. If the video display device is lower in resolution, an application of this embodiment makes it necessary to downscale the partial high-resolution display to display them at the same coordinate.

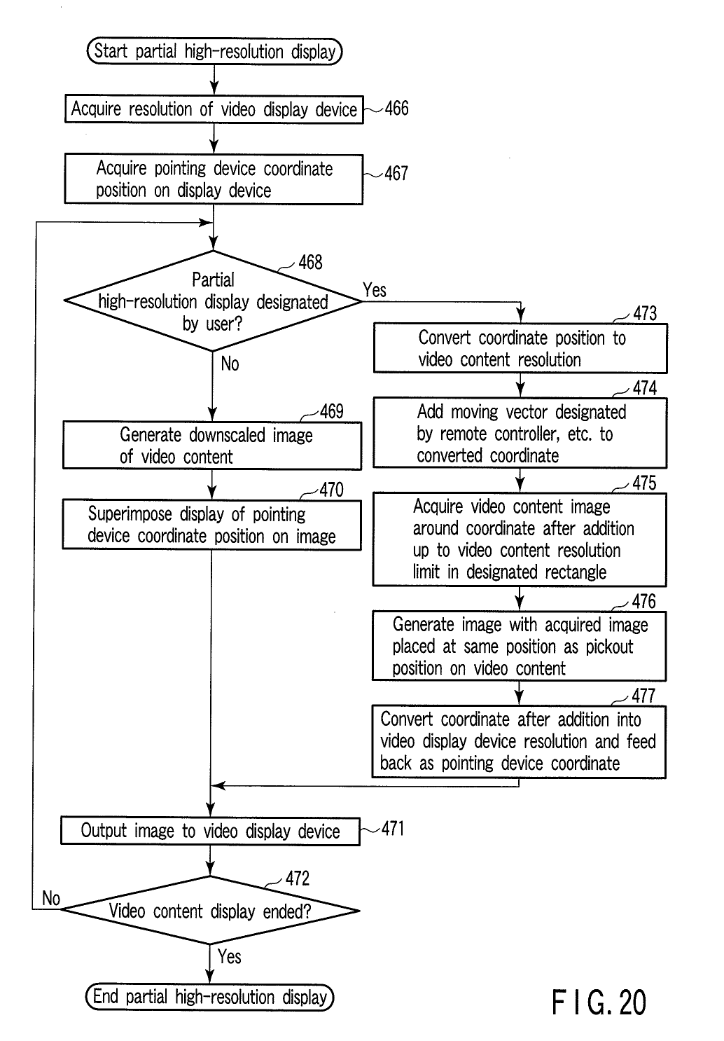

FIG. 20 is a flowchart showing the partial high-resolution display operation according to the eleventh embodiment.

At block 466, the resolution of the video display device 14 is acquired.

At block 467, the coordinate of the pointing device on the video display device 14 is acquired.

At block 468, it is determined whether the partial high-resolution display mode is selected by the user. If the partial high-resolution display mode is selected, the flow goes to block 473. If the partial high-resolution display mode is not selected, the flow goes to block 469.

At block 469, a downscaled image of the video content is generated.

At block 470, the cursor displayed at the coordinate position of the pointing device is superimposed on the downscaled image.

At block 471, this image is output to the video display device 14.

At block 472, it is determined whether the video content display ends or not. If the video content display ends, the process terminates, while the flow returns to block 468 otherwise.

If the partial high-resolution display mode is selected, the coordinate of the position designated by the pointing device is converted to the coordinate of the video content at block 473.

At block 474, the moving vector designated by the remote controller or the like is added to the coordinate after conversion.

At block 475, the image of the video content is acquired in an area of a predetermined shape designated around the acquired coordinate after addition. For example, the image in a rectangular area of a predetermined size with the center at the acquired coordinate after addition is acquired. The resolution of the acquired image is the maximum one in a range not exceeding the resolution limit value of the video content as long as the resolution of the video content in the rectangular area does not exceed the resolution limit value. If the resolution of the video content in the rectangular area does not exceed the resolution limit, the video content is acquired as it is. If the resolution of the video content in the rectangular area exceeds the resolution limit, on the other hand, the video content is acquired after downscaling the resolution to the resolution limit value.

At block 476, an image placed on the video content at the same coordinate as the pickout position of the acquired image is generated as shown in FIG. 21.

At block 477, the coordinate after addition is converted into the coordinate of the video display device 14 and set as the coordinate of the pointing device. Thereafter, the flow goes to block 471.

The embodiments described above relate to the partial high-resolution display mode in which only a particular part of the video content is picked out in keeping with the reproduction rule of the video content, and only the particular part is displayed as a high-precision image. According to the embodiments below, on the other hand, the partial high-resolution display is limited to a narrower area than in the aforementioned embodiments (with the resolution reduced to the resolution limit value or less), and the other areas of the video content (the remaining resolution) are displayed at the same time as a low-resolution display area. In this way, a specified area is displayed in high precision, while the other area is displayed as an image having the lowest resolution, thereby realizing the display easy to grasp the whole image of the video content.

### Twelfth Embodiment

According to the twelfth embodiment, the original resolution of the video content is identical with the resolution of the video display device 14. Assume that like in the first embodiment, the coordinate designated in advance is recorded in the storage as a desired part where the image is displayed in high precision.

First, the time stamp of the video content is acquired, and the coordinate of the previously recorded video content corresponding to the particular time stamp is acquired. Next, the video content is picked out in a size smaller than the resolution limited by the reproduction rule from the particular coordinate in the designated rectangle. In the process, the shape for pickout is not defined as in the embodiments described above. Nevertheless, the twelfth embodiment is different in that the resolution limited by the reproduction rule is shared between the high-resolution display part and the remaining low-resolution display part. As a result, the size of the pickout area is limited considerably more than the resolution limit under the reproduction rule. In other words, the area is reduced in size.

An image obtained by subtracting the high-resolution image from the video content is downscaled in such a manner the number of pixels is reduced to a value obtained by subtracting the resolution of the high-resolution image from the resolution limit according to the reproduction rule. The downscaled image thus obtained constitutes the data of the low-resolution part, and this image is combined with the picked-out high-resolution display part to make up an image limited by the reproduction rule.

If the reproduction rule permits the upscaling of the image that has been limited in resolution, the display image of the low-precision display part is generated by upscaling the low-resolution part to the resolution of the original video content and the video display device 14.

By adding the high-resolution display part to the aforementioned low-resolution display part, one image of the video content is generated. As a result, while meeting the reproduction rule, the specified part can be displayed in high precision while the overall image of the video content can also displayed in low precision. This display is called the non-uniform resolution display, or especially, the non-uniform resolution display #1 if the resolution of the video content is equal to the resolution of the video display device 14. In the non-uniform resolution display, however, it is essential that the reproduction rule permits the upscaling of an image that has been limited in resolution.

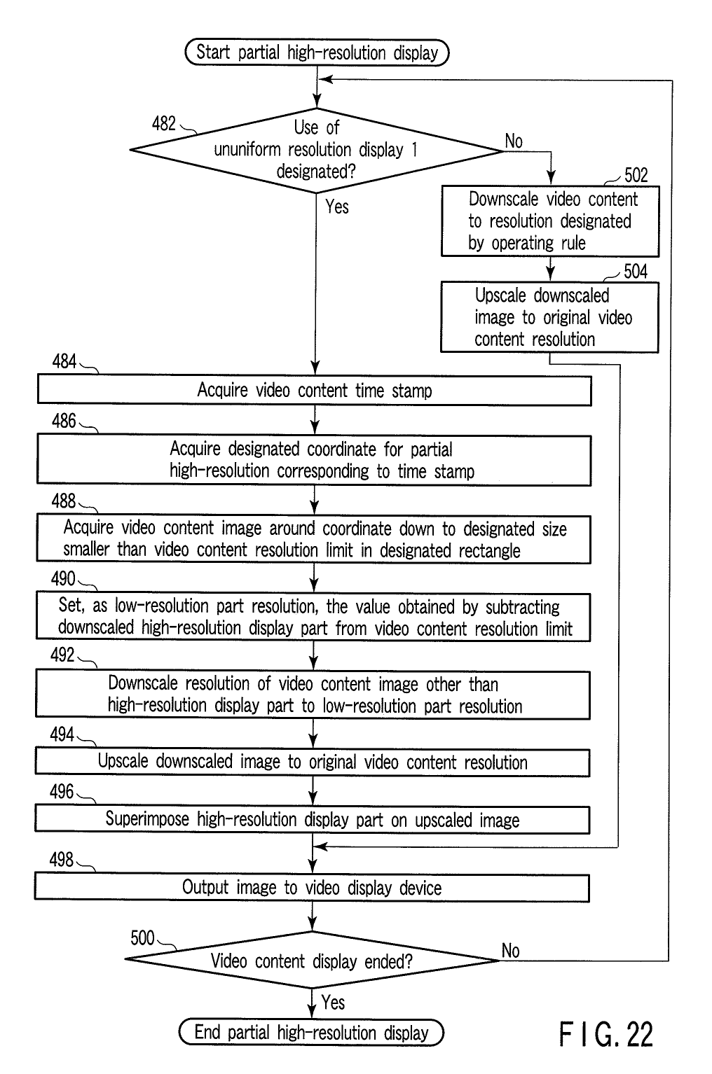

FIG. 22 is a flowchart showing the partial high-resolution display operation according to the twelfth embodiment.

At block 482, it is determined whether the use of the non-uniform resolution display #1 is designated or not. If the use of the non-uniform resolution display #1 is designated, the flow goes to block 484, while the flow goes to block 502 otherwise.

At block 484, the time stamp of the video content is acquired.

At block 486, the designated coordinate for attaining the partial high resolution display recorded in correspondence with the time stamp is acquired.

At block 488, the image of the video content (high-resolution display part) having a size smaller than the resolution limit defined by the reproduction rule is acquired in an area of a predetermined shape designated around the acquired coordinate. For example, the image in a rectangular area of a predetermined size with the center at the acquired coordinate is acquired. The resolution of the acquired image is less than the resolution limit value of the video content.

At block 490, the resolution of the high-resolution display part is subtracted from the resolution limit value of the video content and the result of subtraction is set as the resolution of the low-resolution display part.

At block 492, an image obtained by subtracting the high-resolution image from the video content is downscaled such that the resolution of the image becomes the resolution of the low-resolution display part.

At block 494, the downscaled image is upscaled to the original resolution of the video content.

At block 496, the high-resolution display part is superimposed on the upscaled image.

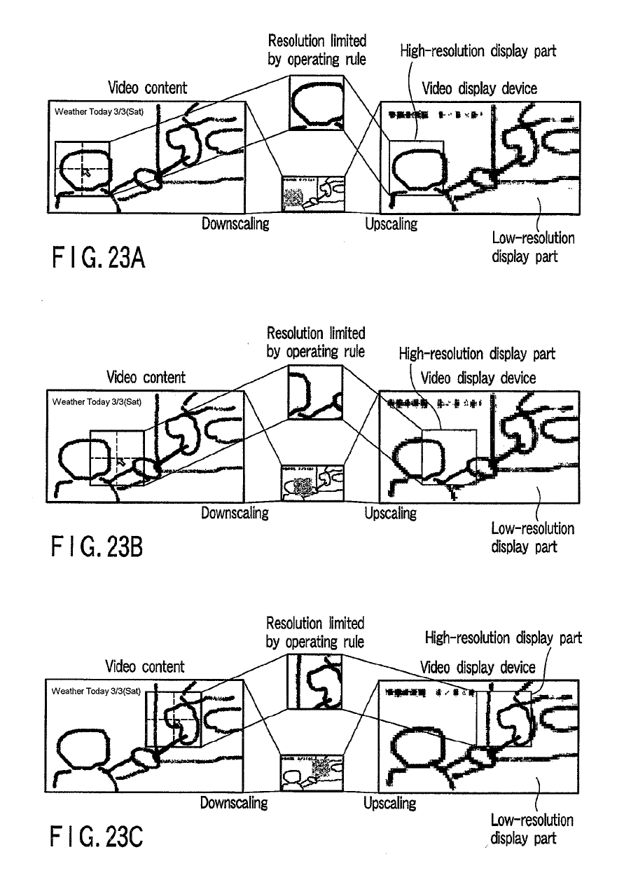

At block 498, this image is output to the video display device 14. FIGS. 23A, 23B and 23C show an example of this image.

At block 500, it is determined whether the video content display ends or not. If the video content display ends, the process terminates, while the flow returns to block 482 otherwise.

Now, an explanation will be given about a case in which the content of full HD size (1920×1080 pixels) are displayed under the condition of 520,000 pixels or less per frame constituting the ICT operation limit according to AACS. Assume that:

the total number of pixels of video content is designated as C,

the total number of pixels of video display device 14 as D,

the number of pixels limited by reproduction rule as Limit,

the number of pixels in high-resolution part as H, the number of pixels in low-resolution part as L, and

the downscale ratio for generating low-resolution part (low-resolution part deterioration rate) as Rate.

Then, these variables hold the following relations:

H+L<Limit

C=H+L/Rate

D=H+L/Rate

In these equations, the fixed values are replaced with specific figures as follows:

H+L<520,000

2,073,600=H+L/Rate

2,073,600=H+L/Rate

Once the low-resolution part deterioration rate (downscale ratio) is determined, for example, the number of pixels available for the high-resolution part and the low-resolution part are determined as shown in Table 1.

TABLE 1

| | | Total No. of | Total No. of | |
|---|---|---|---|---|
| | | pixels in | pixels in | |
| Downscale ratio | | high-resolution | low-resolution | High-resolution |
| (Rate) | | part (H) | part (L) | ratio |
| 1/16 | 0.063 | 415,542 | 1,658,058 | 20.0% |
| 1/12 | 0.083 | 379,380 | 1,694,220 | 18.3% |
| ⅛ | 0.125 | 298,057 | 1,775,543 | 14.4% |
| ⅙ | 0.166 | 210,770 | 1,862,830 | 10.2% |
| ¼ | 0.25 | 2,133 | 2,071,467 | 0.1% |
| ½ | 0.5 | 0 | — (NG) | — (NG) |

In Table 1, the high-resolution ratio is defined as the ratio of the number of pixels (H) displayed in high resolution to the number of pixels over the whole screen of the video display device 14.

Also, the value 1/2 or 1/4 used as the low-resolution deterioration rate (downscale ratio) is considered to indicate the fact that one pixel is generated by downscaling from two pixels or one pixel is generated by downscaling from four pixels, respectively. These numerical figures are reasonable discrete values taking the simplicity of downscaling and subsequent upscaling into consideration.

Table 1 shows that the low-resolution part deterioration rate of 1/2 fails to meet the AACS reproduction rule (specifying 520,000 pixels or less as the resolution per frame), and that the ICT limited number of pixels is substantially consumed by the low-resolution part and therefore even the figure of 1/4 results in a small number of pixels for the high-resolution display part. It is understood that the high-resolution display is possible at 14.4% for the figure of 1/8, and 20.0% for the figure of 1/16.

### Thirteenth Embodiment

The thirteenth embodiment represents a case in which, unlike in the twelfth embodiment, the resolution of the video content is higher than that of the video display device 14. In this case, the downscaling is required to display the whole video content even without the limit under the reproduction rule, and the resolution of the downscaled image is equivalent to the highest precision with which the whole image on display is visible. A specific part of the high-resolution part of the non-uniform resolution display part constitutes an image reduced at this downscale ratio. The resolution of the low-resolution part is the figure (number of pixels) obtained by subtracting the resolution after downscaling the high-resolution display part from the resolution limit under the reproduction rule, and the image obtained by subtracting the high-resolution display part from the video content is downscaled in such a manner as to reduce the number of pixels to the particular figure. The image thus obtained constitutes the original data of the low-resolution part, and the combination of this image with the high-resolution display part picked out and downscaled constitutes an image limited under the reproduction rule.

Like in the twelfth embodiment, the low-resolution display part is required to be upscaled, not up to the resolution of the video content but only up to the resolution of the video display device 14.

The high-resolution display part is added to the low-resolution display part thus generated, so that one image of the video content is generated. As a result, while satisfying the reproduction rule, the specified part can be displayed with the upper-limit high precision that can be displayed on the video display device 14 on the one hand and the whole image of the video content can also be displayed at the same time.

The non-uniform resolution display in which the resolution of the video content is higher than that of the video display device 14 is referred to as the non-uniform resolution display #2.

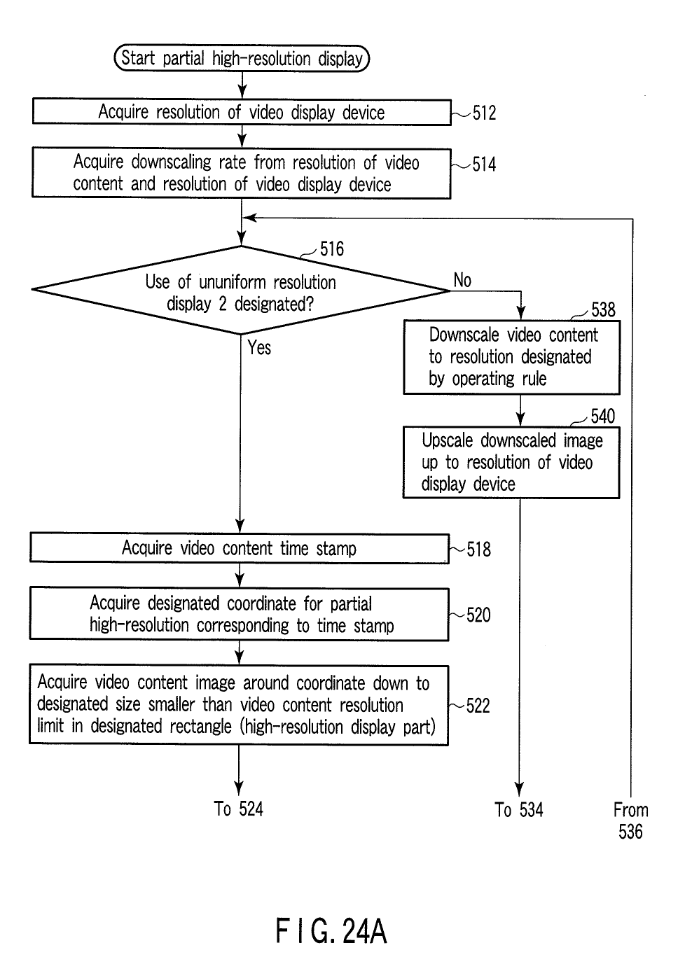

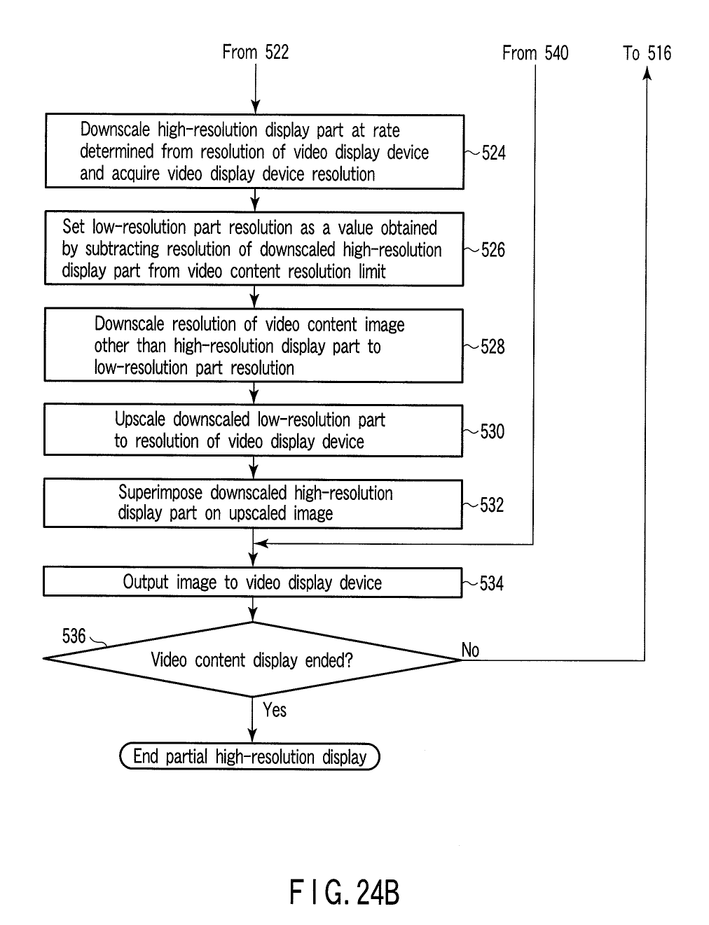

FIGS. 24A and 24B show a flowchart of the partial high-resolution display operation according to the thirteenth embodiment.

At block 512, the resolution of the video display device 14 is acquired.

At block 514, the downscale ratio from the resolution of the video content and the resolution of the video display device 14 is obtained.

At block 516, it is determined whether the use of the non-uniform resolution display #2 is designated or not. If the use of the non-uniform resolution display #2 is designated, the flow goes to block 518, while the flow goes to block 538 otherwise.

At block 518, the time stamps for the video content is acquired.

At block 520, the designated coordinate for achieving the partial high resolution corresponding to the time stamps is acquired.

At block 522, the image of the video content (high-resolution display part) having a size smaller than the resolution limit defined by the reproduction rule is acquired in an area of a predetermined shape designated around the acquired coordinate. For example, the image in a rectangular area of a predetermined size with the center at the acquired coordinate is acquired. The resolution of the acquired image is less than the resolution limit value of the video content.

At block 524, the high-resolution display part is downscaled at the downscale ratio determined from the resolution of the video display device 14.

At block 526, the resolution of the high-resolution display part is subtracted from the resolution limit value of the video content and the result of subtraction is set as the resolution of the low-resolution display part.

At block 528, an image obtained by subtracting the high-resolution image from the video content is downscaled such that the resolution of the image becomes the resolution of the low-resolution display part.

At block 530, the downscaled low-resolution part is upscaled to the resolution of the video display device 14.

At block 532, the downscaled high-resolution display part is superimposed on the upscaled image.

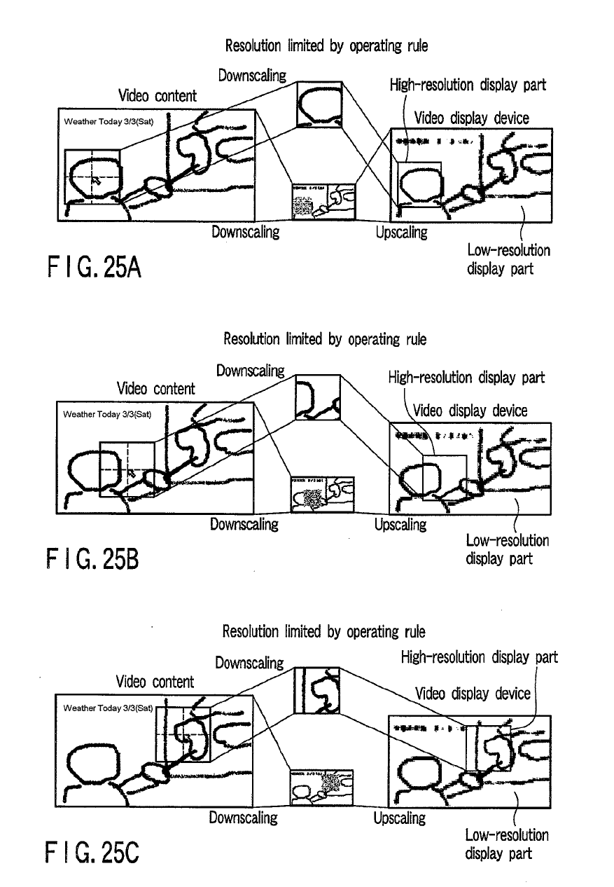

At block 534, the superimposed image is output to the video display device 14, and the flow goes to block 536. An example of this display is shown in FIGS. 25A, 25B, 25C.

At block 536, it is determined whether the video content display ends or not. If the video content display ends, the process terminates, while the flow returns to block 516 otherwise.

At block 538, the video content is downscaled to the resolution designated by the reproduction rule.

At block 540, the downscaled image is upscaled up to the resolution of the video display device 14, and the flow goes to block 534.

An explanation will be given about a case in which the content of full HD size (1920×1080 pixels) is displayed on the video display device 14 having the resolution of 1366×768 under the conditions of 520,000 pixels or less per frame as ICT operation limit according to AACS. Assume that:

the total number of pixels of the video content is designated as C,

the total number of pixels of the video display device 14 as D,

the number of pixels limited by the reproduction rule as Limit,

the number of pixels in the high-resolution part as H,

the number of pixels in the low-resolution part as L, the downscale rate for generating the high-resolution part (high-resolution part deterioration rate) as RateH,

the downscale rate for generating the low-resolution part (low-resolution part deterioration rate) as RateLD, and

the upscale rate for displaying low-resolution part (low-resolution part magnification rate) as RateLU.

These variables hold the following relations:

H+L<Limit

C=H/RateH+L/RateLD

D=H+L×RateLU

D=C/RateH

D=C/(RateLD×RateLU)

RateH=RateLD×RateLU

Filling specific figures in the fixed values as a condition for further study:

C=2,073,600

D=1,049,088

RateH=0.506

H+L<520,000

2,073,600=H/0.506+L/RateLD

1,049,088=H+L×RateLU

0.506=RateLD×RateLU

Assume that RateH=0.5 taking the simplicity of the downscaling into consideration. By determining the low-resolution part deterioration rate, the number of pixels and the low-resolution part magnification rate are determined for the high-resolution part and the low-resolution part as shown in Table 2.

TABLE 2

| | | Low-resolution part | | | |
|---|---|---|---|---|---|
| Downscale ratio | | magnification rate | Total No. of pixels in | Total No. of pixels in | High-resolution |
| (Rate) | | (RateLU) | high-resolution part (H) | low-resolution part (L) | ratio |
| 1/16 | 0.063 | About 8 | 445496 | 603592 | 42.5% |
| 1/12 | 0.083 | About 6 | 417136 | 631952 | 39.8% |
| ⅛ | 0.125 | About 4 | 347733 | 701355 | 33.1% |
| ⅙ | 0.166 | About 3 | 263147 | 785941 | 25.1% |
| ¼ | 0.25 | About 2 | 3200 | 1045888 | 0.3% |
| ½ | 0.5 | About 1 | 0 | — (NG) | — (NG) |

The low-resolution part magnification rate is expressed by an integer into which the error is rounded, taking the simplicity of upscaling into consideration.

Table 2 shows that for the figure of 1/4, the limited number of pixels of ICT are consumed up substantially by the low-resolution part in the non-uniform resolution display #2, and therefore, the number of pixels in the high-resolution display part is small. The high-resolution display at the ratio of 33.1% is possible even for the deterioration rate of 1/8, and 42.5% for the deterioration rate of 1/16. It is understood, therefore, that the ratio of the high-resolution part is remarkably higher than in the case of Table 1.

In similar fashion, an explanation will be given below about the display on the video display device 14 having the resolution of 1366×768 under the same conditions.

C=2,073,600

D=921,600

RateH=0.444 (4/9)

H+L<520,000

2,073,600=H/0.506+L/RateLD

921,600=H+L×RateLU

0.444=RateLD×RateLU

Once the low-resolution part deterioration rate is determined, therefore, the number of pixels and the low-resolution part magnification rate available for the high-resolution part and the low-resolution part are determined as shown in Table 3. Also, the adjustment to make an integer of the low-resolution part magnification rate leads to Table 4.

TABLE 3

| Low-resolution part | | Low-resolution part | | | |
|---|---|---|---|---|---|
| deterioration rate | | magnification rate | Total No. of pixels in | Total No. of pixels in | High-resolution |
| (RateLD) | | (RateLU) | high-resolution part (H) | low-resolution part (H) | ratio |
| 1/16 | 0.063 | 7.047619048 | 453746 | 467854 | 49.2% |
| 1/12 | 0.083 | 5.34939759 | 427877 | 493723 | 46.4% |
| ⅛ | 0.125 | 3.552 | 362994 | 558606 | 39.4% |
| ⅙ | 0.166 | 2.674698795 | 280746 | 640854 | 30.5% |
| ¼ | 0.25 | 1.776 | 3662 | 917938 | 0.4% |
| ½ | 0.5 | 0.888 | 0 | — (NG) | — (NG) |

TABLE 4

| Low-resolution part | | Low-resolution part | | | |
|---|---|---|---|---|---|
| deterioration rate | | magnification rate | Total No. of pixels in | Total No. of pixels in | High-resolution |
| (RateLD) | | (RateLU) | high-resolution part (H) | low-resolution part (H) | ratio |
| 1/18 | 0.0555 | 8 | 462760 | 458840 | 50.2% |
| 1/9 | 0.111 | 4 | 386441 | 535159 | 41.9% |
| 2/9 | 0.222 | 2 | 119322 | 802278 | 12.9% |
| 4/9 | 0.444 | 1 | 0 | 921600 | 0.0% |

### Fourteenth Embodiment

Unlike in the 12th and thirteenth embodiments in which the place of non-uniform resolution display is recorded in advance as in the first embodiment, the fourteenth embodiment represents a case in which like in the second to eleventh embodiments, the place designated by the user through the pointing device is displayed with high resolution in the whole uniform low-resolution display area.

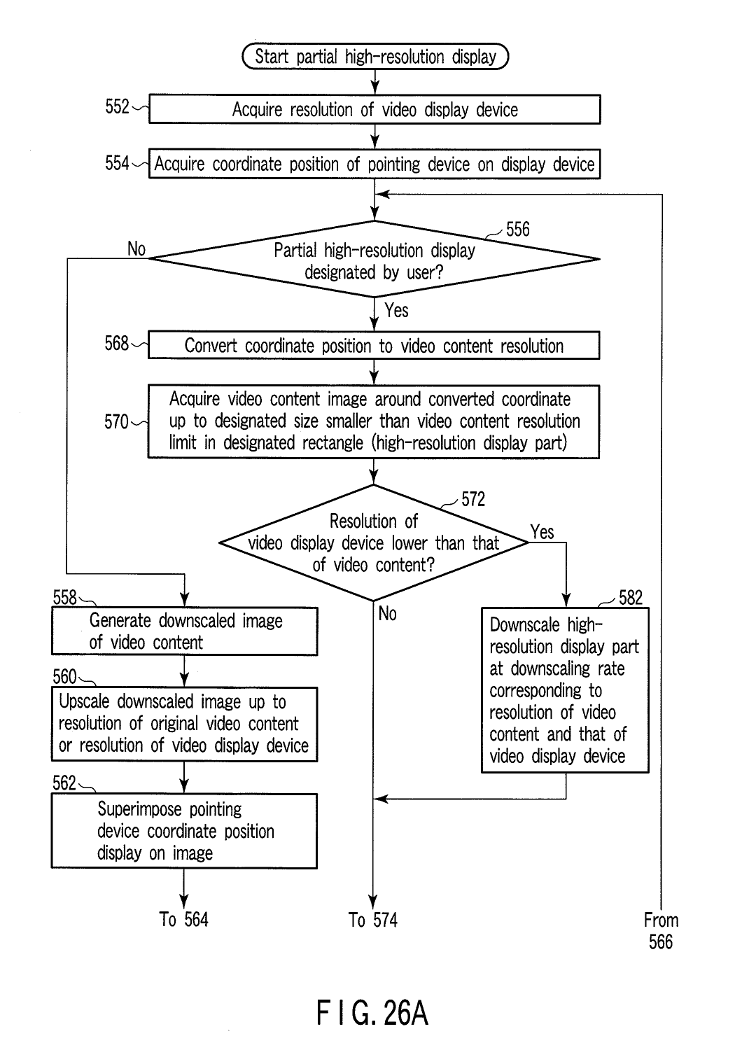

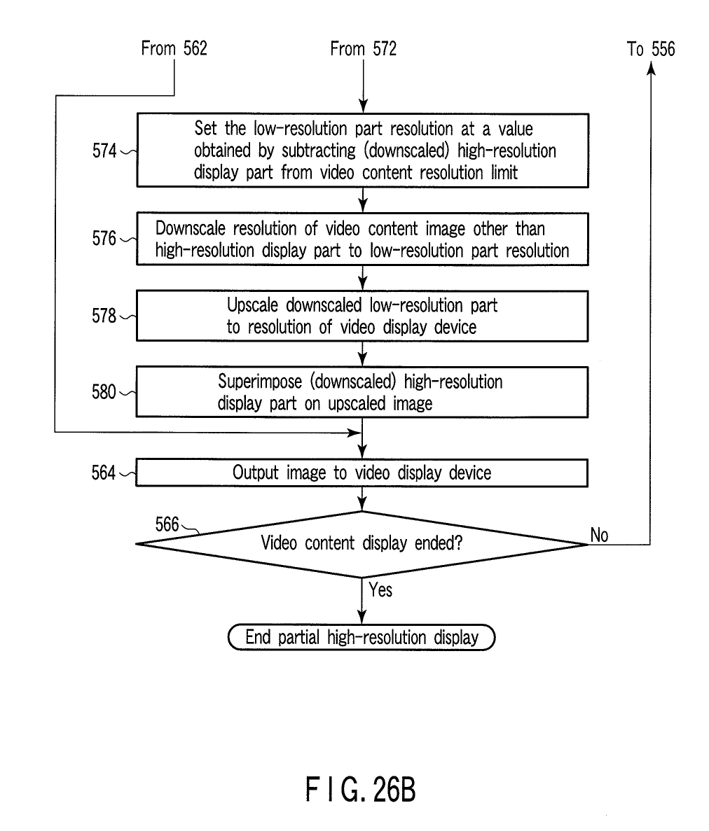

FIGS. 26A and 26B show a flowchart of the partial high-resolution display operation according to the fourteenth embodiment.

At block 552, the resolution of the video display device 14 is acquired.

At block 554, the coordinate position of the pointing device on the video display device 14 is acquired.

At block 556, it is determined whether the partial high-resolution display mode (including the non-uniform resolution display #1 and the non-uniform resolution display #2) is selected by the user or not. If the partial high-resolution display mode is selected, the flow goes to block 568, while the flow goes to block 558 otherwise.

At block 558, a downscaled image of the video content is generated.

At block 560, the downscaled image is upscaled up to the resolution of the original video content or the resolution of the video display device 14.

At block 562, the cursor displayed at the coordinate position of the pointing device is superimposed on the upscaled image.

At block 564, this superimposed image is output to the video display device 14.

At block 566, it is determined whether the video content display ends or not. If the video content display ends, the process terminates, while the flow returns to block 556 otherwise.

If the partial high-resolution display mode is selected at block 556, on the other hand, the coordinate position of the pointing device is converted to the resolution (coordinate) of the video content at block 568.

At block 570, the image of the video content (high-resolution display part) having a size smaller than the resolution limit defined by the reproduction rule is acquired in an area of a predetermined shape designated around the acquired coordinate after conversion. For example, the image in a rectangular area of a predetermined size with the center at the acquired coordinate is acquired. The resolution of the acquired image is less than the resolution limit value of the video content.

At block 572, it is determined whether the resolution of the video display device 14 is lower than that of the video content or not. If the resolution of the video display device 14 is lower than that of the video content, the flow goes to block 582, while the flow goes to block 574 otherwise.

At block 574, the resolution of the high-resolution display part is subtracted from the resolution limit value of the video content and the result of subtraction is set as the resolution of the low-resolution display part.

At block 576, the resolution of the image of the video content other than the high-resolution display part is downscaled to the resolution of the low-resolution part.

At block 578, the downscaled low-resolution part is upscaled to the resolution of the video display device 14.

At block 580, the downscaled high-resolution display part is superimposed on the upscaled image. Thereafter, the flow goes to block 564.

At block 582, the high-resolution display part is downscaled at a rate corresponding to the resolution of the video content and the resolution of the video display device 14. Thereafter, the flow goes to block 574.

Though not shown in FIGS. 26A and 26B, the fourteenth embodiment may be modified in such a manner that like in the third embodiment, the non-uniform resolution display mode is returned to the whole uniform low-resolution display mode at a timing designated by the user.

### Fifteenth Embodiment

The fifteenth embodiment is modified from the fourteenth embodiment in such a manner that like in the third embodiment, the pickout position of the high-resolution display part is moved by the remote controller or the like during the non-uniform resolution display.

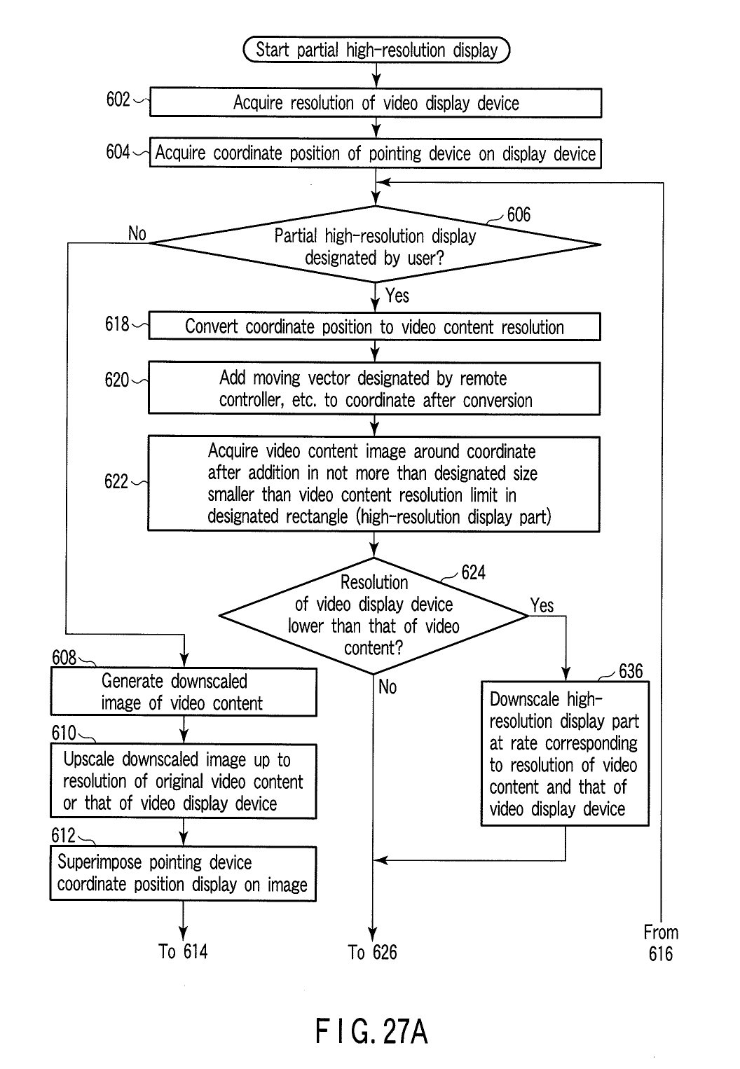

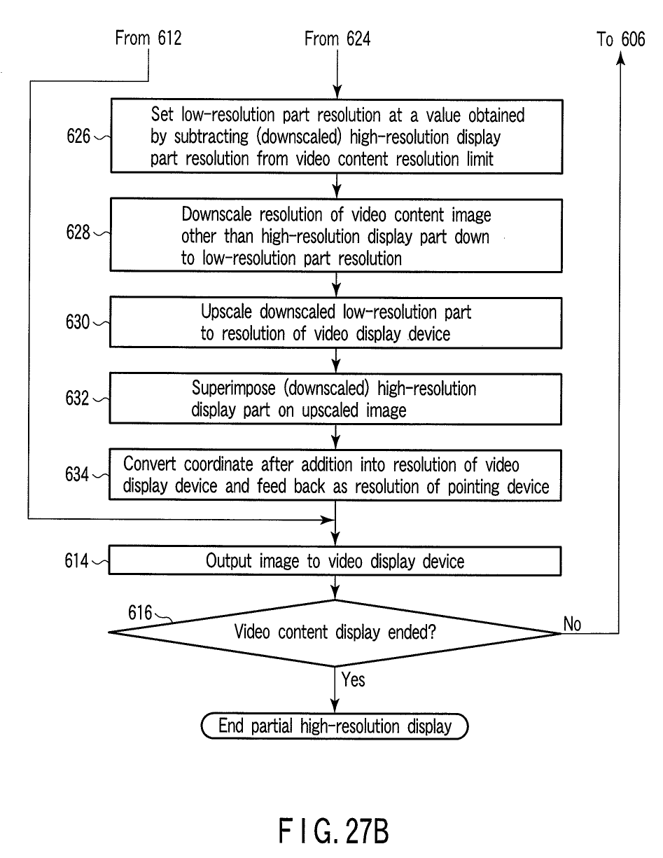

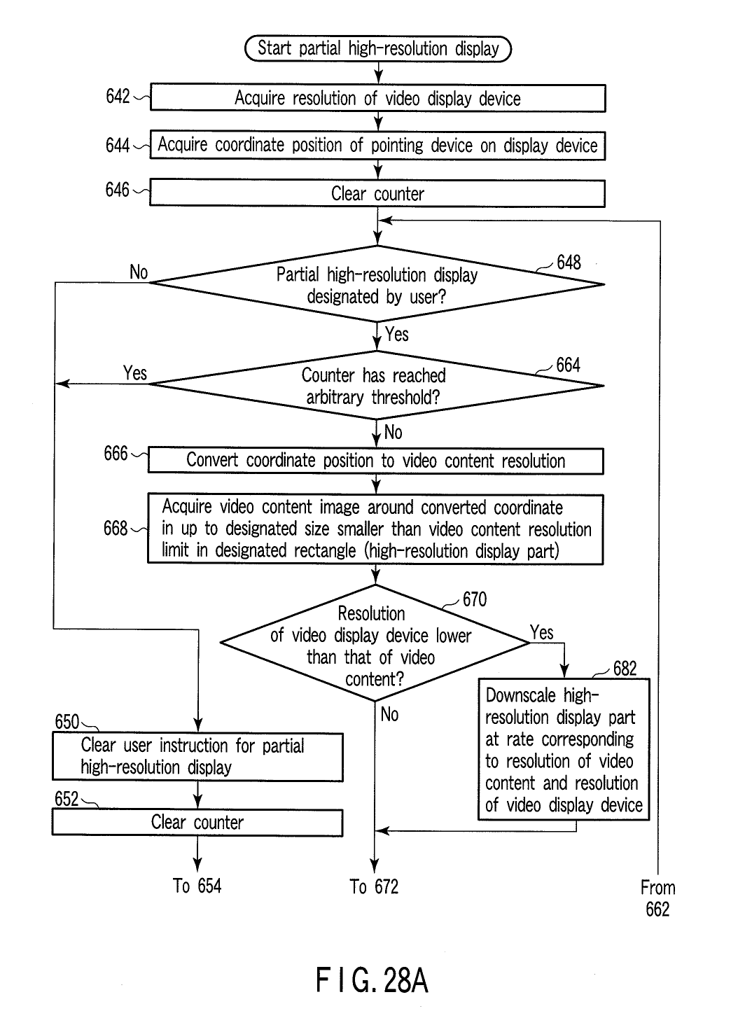

FIGS. 27A and 27B show a flowchart of the partial high-resolution display operation according to the fifteenth embodiment.

At block 602, the resolution of the video display device 14 is acquired.

At block 604, the coordinate position of the pointing device on the video display device 14 is acquired.

At block 606, it is determined whether the partial high-resolution display mode is selected by the user or not. If the partial high-resolution display mode is selected, the flow goes to block 618, while the flow goes to block 608 otherwise.

At block 608, a downscaled image of the video content is generated.

At block 610, the downscaled image is upscaled up to the resolution of the original video content or the resolution of the video display device 14.

At block 612, the cursor displayed at the coordinate position of the pointing device is superimposed on the upscaled image.

At block 614, this superimposed image is output to the video display device 14.

At block 616, it is determined whether the video content display ends or not. If the video content display ends, the process terminates, while the flow returns to block 606 otherwise.

At block 618, the coordinate position of the pointing device is converted to the resolution (coordinate) of the video content.

At block 620, the moving vector designated by the remote controller or the like is added to the coordinate after conversion.

At block 622, the image of the video content (high-resolution display part) having a size smaller than the resolution limit defined by the reproduction rule is acquired in an area of a predetermined shape designated around the acquired coordinate after addition. For example, the image in a rectangular area of a predetermined size with the center at the acquired coordinate is acquired. The resolution of the acquired image is less than the resolution limit value of the video content.

At block 624, it is determined whether the resolution of the video display device 14 is lower than that of the video content or not. If the resolution of the video display device 14 is lower than that of the video content, the flow goes to block 636, while the flow goes to block 626 otherwise.

At block 626, the resolution of the high-resolution display part is subtracted from the resolution limit value of the video content and the result of subtraction is set as the resolution of the low-resolution display part.

At block 628, the resolution of the image of the video content other than the high-resolution display part is downscaled to the resolution of the low-resolution part.

At block 630, the downscaled low-resolution part is upscaled to the resolution of the video display device 14.

At block 632, the downscaled high-resolution display part is superimposed on the upscaled image.

At block 634, the coordinate after addition is converted into the resolution (coordinate) of the video display device 14 and set as the coordinate of the pointing device. Thereafter, the flow goes to block 614.

At block 636, the high-resolution display part is downscaled at a rate corresponding to the resolution of the video content and the resolution of the video display device 14. Thereafter, the flow goes to block 626.

### Sixteenth Embodiment

The sixteenth embodiment is modified from the fourteenth embodiment in such a manner that like in the sixth embodiment, the non-uniform resolution display mode is changed to the whole uniform low-resolution display mode regardless of the user instruction upon lapse of a predetermined time from the start of the non-uniform resolution display mode.

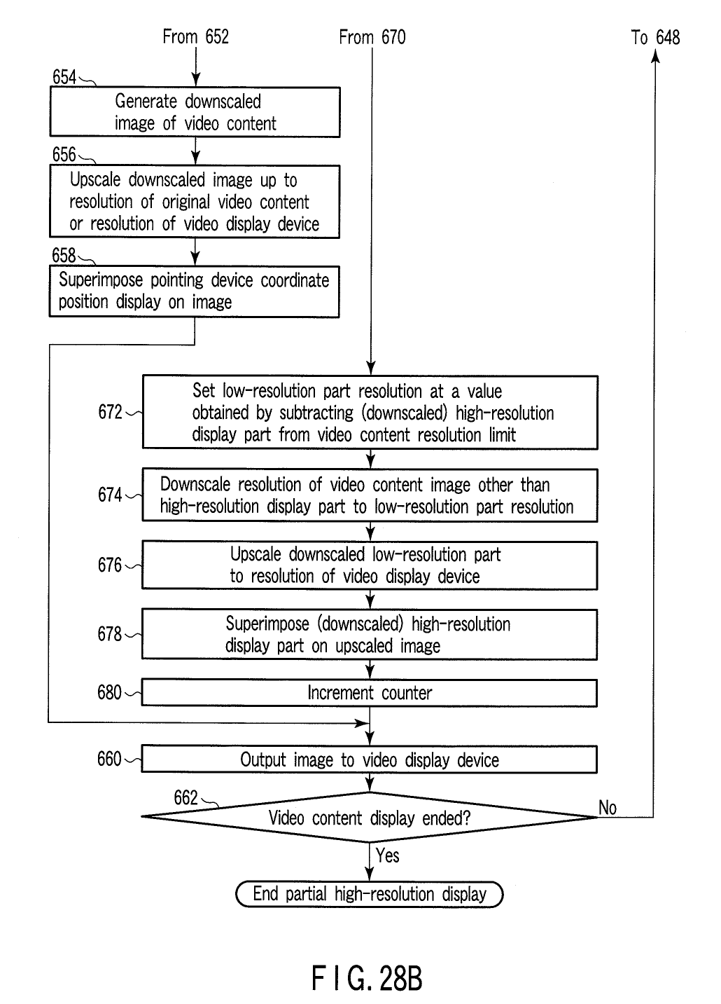

FIGS. 28A and 28B show a flowchart of the partial high-resolution display operation according to the sixteenth embodiment.

At block 642, the resolution of the video display device 14 is acquired.

At block 644, the coordinate position of the pointing device on the video display device 14 is acquired.

At block 646, the counter is cleared.

At block 648, it is determined whether the partial high-resolution display mode is selected by the user or not. If the partial high-resolution display mode is selected, the flow goes to block 664, while the flow goes to block 650 otherwise.

At block 650, the user instruction for the partial high-resolution display mode is cleared.

At block 652, the counter is cleared.

At block 654, a downscaled image of the video content is generated.

At block 656, the downscaled image is upscaled up to the resolution of the original video content or the resolution of the video display device 14.

At block 658, the cursor displayed at the coordinate position of the pointing device is superimposed on the upscaled image.

At block 660, this superimposed image is output to the video display device 14.

At block 662, it is determined whether the video content display ends or not. If the video content display ends, the process terminates, while the flow returns to block 648 otherwise.

At block 664, it is determined whether the counter has reached an arbitrary threshold value or not. If the counter has reached an arbitrary threshold value, the flow goes to block 650, while the flow goes to block 666 otherwise.

At block 666, the coordinate position of the pointing device is converted to the resolution (coordinate) of the video content.

At block 668, the image of the video content (high-resolution display part) having a size smaller than the resolution limit defined by the reproduction rule is acquired in an area of a predetermined shape designated around the acquired coordinate after conversion. For example, the image in a rectangular area of a predetermined size with the center at the acquired coordinate is acquired. The resolution of the acquired image is less than the resolution limit value of the video content.

At block 670, it is determined whether the resolution of the video display device 14 is lower than that of the video content or not. If the resolution of the video display device 14 is lower than that of the video content, the flow goes to block 682, while the flow goes to block 672 otherwise.

At block 672, the resolution of the high-resolution display part is subtracted from the resolution limit value of the video content and the result of subtraction is set as the resolution of the low-resolution display part.

At block 674, the resolution of the image of the video content other than the high-resolution display part is downscaled to the resolution of the low-resolution part.

At block 676, the downscaled low-resolution part is upscaled to the resolution of the video display device 14.

At block 678, the downscaled high-resolution display part is superimposed on the upscaled image.

At block 680, the counter is incremented. Thereafter, the flow goes to block 660.

At block 682, the high-resolution display part is downscaled at a rate corresponding to the resolution of the video content and the resolution of the video display device 14. Thereafter, the flow goes to block 672.

### Seventeenth Embodiment

The seventeenth embodiment is modified from the fourteenth embodiment in such a manner that like in the seventh embodiment, upon detection of a dividing point of the video content such as the chapter boundary during the non-uniform resolution display, the whole uniform low-resolution display mode is changed restored automatically regardless of the user instruction.

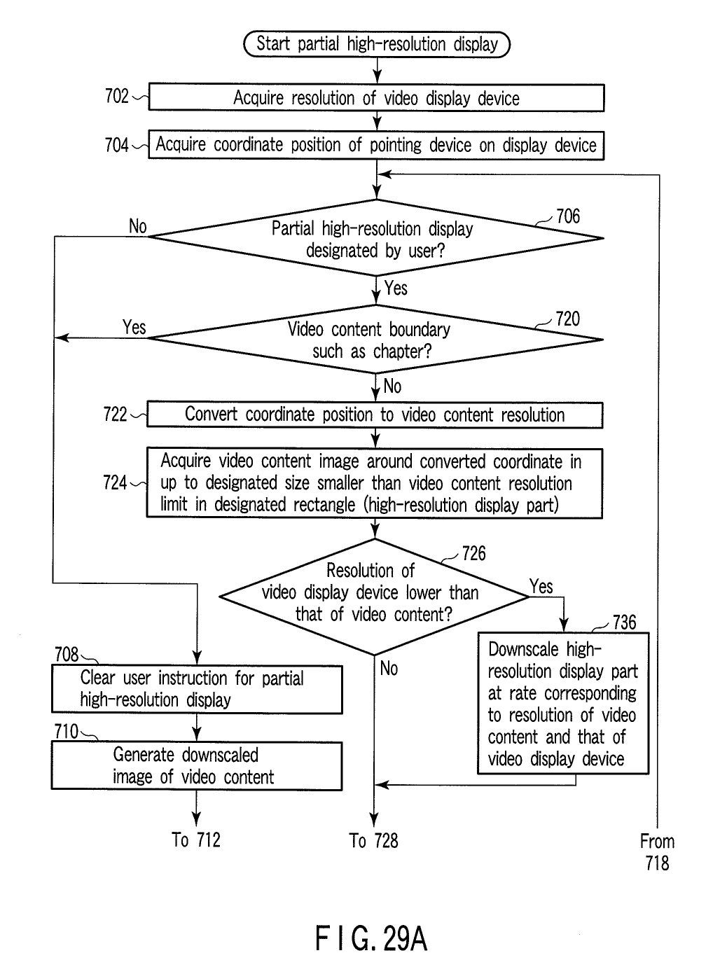

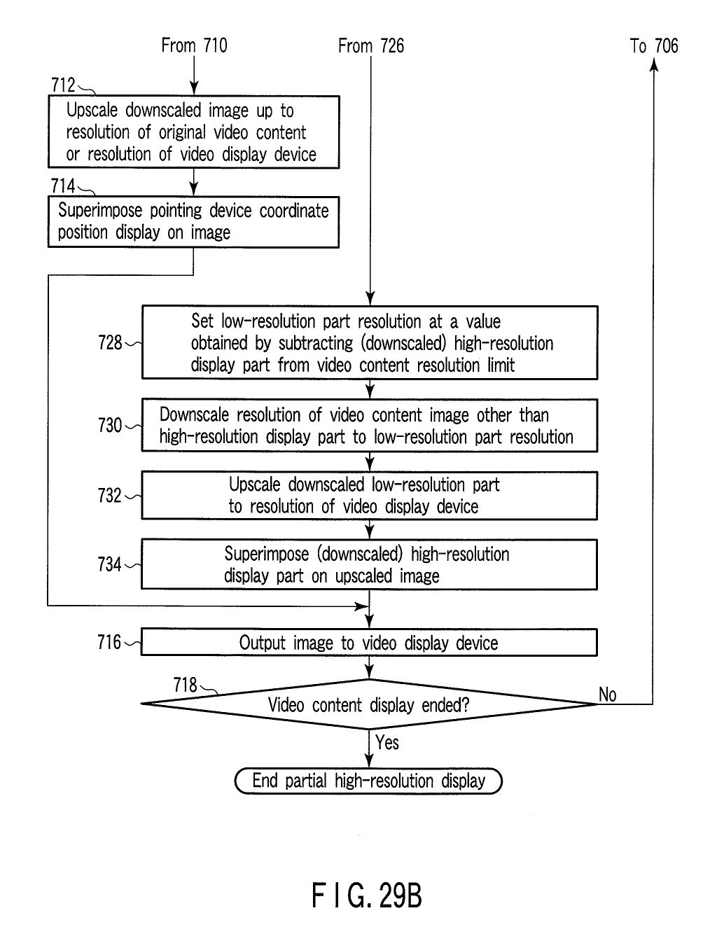

FIGS. 29A and 29B show a flowchart of the partial high-resolution display operation according to the seventeenth embodiment.

At block 702, the resolution of the video display device 14 is acquired.

At block 704, the coordinate position of the pointing device on the video display device 14 is acquired.

At block 706, it is determined whether the partial high-resolution display mode is selected by the user or not. If the partial high-resolution display mode is selected, the flow goes to block 720, while the flow goes to block 708 otherwise.

At block 708, the user instruction for the partial high-resolution display mode is cleared.

At block 710, a downscaled image of the video content is generated.

At block 712, the downscaled image is upscaled up to the resolution of the original video content or the resolution of the video display device 14.

At block 714, the cursor displayed at the coordinate position of the pointing device is superimposed on the upscaled image.

At block 716, this superimposed image is output to the video display device 14.

At block 718, it is determined whether the video content display ends or not. If the video content display ends, the process terminates, while the flow returns to block 706 otherwise.

At block 720, it is determined whether a boundary of the video content such as a chapter exists or not. If a boundary of the video content exists, the flow goes to block 708, while the flow goes to block 722 otherwise.

At block 722, the coordinate position of the pointing device is converted to the resolution (coordinate) of the video content.

At block 724, the image of the video content (high-resolution display part) having a size smaller than the resolution limit defined by the reproduction rule is acquired in an area of a predetermined shape designated around the acquired coordinate after conversion. For example, the image in a rectangular area of a predetermined size with the center at the acquired coordinate is acquired. The resolution of the acquired image is less than the resolution limit value of the video content.

At block 726, it is determined whether the resolution of the video display device 14 is lower than that of the video content or not. If the resolution of the video display device 14 is lower than that of the video content, the flow goes to block 736, while the flow goes to block 728 otherwise.

At block 728, the resolution of the high-resolution display part is subtracted from the resolution limit value of the video content and the result of subtraction is set as the resolution of the low-resolution display part.

At block 730, the resolution of the image of the video content other than the high-resolution display part is downscaled to the resolution of the low-resolution part.

At block 732, the downscaled low-resolution part is upscaled to the resolution of the video display device 14.

At block 734, the downscaled high-resolution display part is superimposed on the upscaled image. Thereafter, the flow goes to block 716.

At block 736, the high-resolution display part is downscaled at a rate corresponding to the resolution of the video content and the resolution of the video display device 14. Thereafter, the flow goes to block 728.

As explained above, according to the embodiments, an arbitrary part of the image is picked out and displayed if the display resolution of the video content is limited more than the original resolution of the video content. In this way, the particular part of the image can be displayed with a high precision. Also, the provision of a high-precision part and a low-precision part under a limitation makes it possible to realize a high-precision display for an arbitrary part of the screen while the flow goes to the same time grasping the whole screen of the video content.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video reproduction device in which a resolution of a video content is limited to a predetermined value, the device comprising:
a display module configured to reduce the resolution of the video content to the predetermined value and to display the reduced resolution content in a screen;
an input module configured to select a part of the reduced resolution content; and
a recording module configured to save a selected part of the reduced resolution content together with a time stamp of the video content.

2. A video reproduction device in which a resolution of a video content is limited to a predetermined value, the device comprising:
an extraction module configured to extract a part of the video content; and
a display module configured to display an extracted part of the video content with a number of pixels smaller than a number of pixels corresponding to the predetermined value of the resolution.

3. A video reproduction device in which a resolution of a video content is limited to a predetermined value, the device comprising:
a display module configured to display a the reduced resolution content in which the resolution is reduced to the predetermined value;
an input module configured to select a part of the reduced resolution content;
an extraction module configured to extract a selected part from the reduced resolution content; and
a display control module configured to change a display of the reduced resolution content to a display of a partial high-resolution image of an extracted part with a number of pixels smaller than a number of pixels corresponding to the predetermined value of the resolution.

4. The video reproduction device of claim 3, further comprising a restoring module configured to change the display of the partial high-resolution image to the display of the reduced resolution content at a time specified by a user while the partial high-resolution image is displayed.

5. The video reproduction device of claim 3, further comprising a moving module configured to select a portion of the extracted part by an operation of a user while the partial high-resolution image is displayed.

6. The video reproduction device of claim 3, further comprising an indicator module configured to display an indication of which part is extracted from the reduced resolution content while the partial high-resolution image is displayed.

7. The video reproduction device of claim 3, further comprising an indicator module configured to display an indication of a direction in which the extracted part is selectable while the partial high-resolution image is displayed.

8. The video reproduction device of claim 3, further comprising a restoring module configured to change the display of the partial high-resolution image to the display of the reduced resolution content.

9. The video reproduction device of claim 3, further comprising an indicator module configured to display an indication of which part is extracted from the reduced resolution content when a display of the partial high-resolution image is changed to a display of the reduced resolution content.

10. The video reproduction device of claim 3, wherein the display control module is configured to display one of the partial high-resolution image or the reduced resolution content at a central area of a screen of the display module when a resolution of the display device is higher than the predetermined value.

11. The video reproduction device of claim 3, wherein the display control module is configured to display the partial high-resolution image at such a area of a screen which is configured to display the reduced resolution content that corresponds to the selected part when a resolution of the display device is higher than the predetermined value.

12. A video reproduction device in which a resolution of a video content is limited to a predetermined value, the device comprising:
a display module configured to display a reduced resolution content in which the resolution is reduced to the predetermined value;
an input module configured to select a part of the reduced resolution content;
an extraction module configured to extract a designated part from the reduced resolution content; and
a display control module configured to display a partial high-resolution image at an extracted part with a number of pixels smaller than a number of pixels corresponding to the predetermined value of the resolution and a partial low-resolution image at a remaining part with a predetermined number of pixels, wherein a sum of the number of pixels of the partial high-resolution image and the number of pixels of the partial low-resolution image is smaller than the number of pixels corresponding to the predetermined value of the resolution

13. The video reproduction device of claim 12, further comprising a restoring module configured to change the display of the partial high-resolution image and of the partial low-resolution image to a display of the reduced resolution content.

14. The video reproduction device of claim 12, further comprising a moving module configured to specify a portion of the extracted part by an operation of a user while the partial high-resolution image and the partial low-resolution image are displayed.

15. The video reproduction device of claim 12, further comprising an indicator module configured to display an indication of which part is extracted from the reduced resolution content while the partial high-resolution image and the partial low-resolution image are displayed.

16. The video reproduction device of claim 12, further comprising an indicator module configured to display an indication of a direction in which the extracted part is selectable while the partial high-resolution image and the partial low-resolution image are displayed.
